(19) United States
(12) Patent Application Publication
(10) Pub. No.: US 2012/0026215 A1
(43) Pub. Date: Feb. 2, 2012

(54) DISPLAY DEVICE AND DRIVE METHOD FOR DISPLAY DEVICES

(76) Inventors: Masakazu Takeuchi, Osaka-shi (JP); Hideki Morii, Osaka-shi (JP); Tetsuya Umehara, Osaka-shi (JP); Chihiro Watanabe, Osaka-shi (JP); Yuhko Hisada, Osaka-shi (JP)

(21) Appl. No.: 13/138,595

(22) PCT Filed: Feb. 5, 2010
(86) PCT No.: PCT/JP2010/000714

§ 371 Date: Sep. 9, 2011

(30) Foreign Application Priority Data
Apr. 30, 2009 (JP) 2009-110480

(51) Int. Cl. G09G 5/02

(52) U.S. Cl. 345/691

(57) ABSTRACT

A display device supplies, during a vertical blanking interval, a data signal for a gray display to each data signal line so as to cause the each data signal line to retain the data signal for the gray display. In at least one example embodiment, the data signal for the gray display has a polarity identical to a polarity of a data signal supplied immediately before the vertical blanking interval. This achieves a display device and a method for driving a display device in each of which, while an AC driving is carried out so that (i) data signals having opposite polarities are written to respective picture elements adjacent to each other within the same row, (ii) a polarity of a data signal supplied to each data signal line is reversed at least once during one vertical period, and (iii) a polarity of a data signal written to each picture element is reversed for every predetermined period, an effective value of a voltage applied to liquid crystal is less likely to differ between a picture element to which a data signal having a positive polarity is written and a picture element to which a data signal having a negative polarity is written.

### TECHNICAL FIELD

The present invention relates to a display device which employs an AC driving.

### BACKGROUND ART

In an active matrix liquid crystal display device, parasitic capacitance is formed between a picture element electrode and a data signal line. The parasitic capacitance is large especially when the picture element electrode and the data signal line are arranged so as to face each other.

There have been known liquid crystal display devices each of which is Configured, for the purpose of increasing an aperture ratio of picture elements, such that (i) the data signal line is arranged so that at least part thereof is immediately below the picture element electrode and (ii) picture element electrodes adjacent to each other within the same row are arranged at a smaller interval. Out of such liquid crystal display devices, a liquid crystal display device which carries out a display by using light from a backlight is configured such that a transparent insulating film having a relatively large thickness is provided between data signal lines and picture element electrodes so as to avoid, as much as possible, a situation in which the data signal lines block light from entering a liquid crystal layer. FIG. 7 illustrates how such a liquid crystal display device disclosed in Patent Literature 1 is configured.

FIG. 7(a) is a plan view schematically illustrating picture element electrodes. FIG. 7(b) is a cross-sectional view schematically illustrating the picture element electrodes. As illustrated in FIG. 7(b), each of source lines (data signal lines) 13 is arranged so as to have (i) a region facing a picture element electrode 11 of a picture element (in the Description, such a picture element is hereinafter referred to as a “subject picture element”) to which a data signal supplied through the each of the source lines 13 is written and (ii) a region facing a picture element electrode 11 of a picture element (in the Description, such a picture element is hereinafter referred to as an “adjacent picture element”) which is one of picture elements each of which is adjacent to the subject picture element within the same row. Therefore, the picture element electrodes 11 of picture elements adjacent to each other are spaced at a small interval, and a relatively large parasitic capacitance 15 is formed not only between the each of the source lines 13 and the picture element electrode 11 of the subject picture element but also between the each of the source lines 13 and the picture element electrode 11 of the adjacent picture element. That is, each picture element electrode 11 is highly capacitively-coupled with each of two adjacent source lines 13, i.e., a source line 13 corresponding to the subject picture element and a source line 13 corresponding to the adjacent picture element.

The each of the source lines 13 is connected, via a TFT 12, with the picture element electrode 11 of the subject picture element. An interlayer insulating film provided between the each of the source lines 13 and the picture element 11 is a special resin 16.

### CITATION LIST

### Patent Literature

Patent Literature 1
Japanese Patent Application Publication, Tokukai, No. 2006-23710 A (Publication Date: Jan. 26, 2006)

### SUMMARY OF INVENTION

### Technical Problem

However, an active matrix liquid crystal display device such as the foregoing conventional liquid crystal display device, in which some kind of parasitic capacitance tends to be formed between adjacent picture element electrodes and a data signal line, causes the following problem.

Assume that, in a liquid crystal display device in which a column (R1, R2, . . . ) of R picture elements, a column (G1, G2, . . . ) of G picture elements, and a column (B1, B2, . . . ) of B picture elements are arranged in this order (see FIG. 8), an AC driving is carried out so that (i) data signals having opposite polarities are written to respective picture elements adjacent to each other within the same row, (ii) a polarity of a data signal supplied to each data signal line is reversed at least once during one (1) vertical period, and (iii) a polarity of a data signal written to each picture element is reversed for every one (1) frame. In the following example, in each column during each frame, a polarity of a data signal to be written is reversed, remains the same for two horizontal periods, and thereafter is reversed again. Note, however, that the example encompasses a case in which a general inversion driving is carried out so that, in each column, a polarity of a data signal to be written is reversed and thereafter remains the same for k (k is a natural number) horizontal period(s). In a case where k=1, the inversion driving is equivalent to a dot inversion driving.

For example, assume that the number of rows of picture elements effective for a display is 768 when the AC driving of FIG. 8 is carried out. In this case, during a vertical blanking interval, a data signal stops being supplied to each data signal line so that the each data signal line retains a data signal which was supplied to a picture element in a 768-th row, i.e., the last row. According to FIG. 8, 769-th row and later correspond to the vertical blanking interval.

Further, assume that an image having a single color of R, G, B or the like is displayed in FIG. 8. For example, an image having a single color of R is displayed. In such a case, in a case where for example k=1, the following waveforms are obtained during a same frame in each column to which an R data signal is supplied. That is, (i) an electric potential Vd of a picture element electrode to which a data signal having a positive polarity is written has a waveform shown in FIG. 9(a) and (ii) an electric potential Vd of a picture element electrode to which a data signal having a negative polarity is written has a waveform shown in FIG. 9(b). Each of FIG. 9(a) and FIG. 9(b) shows both a waveform of an electric potential of an R data signal Vsr and a waveform of an electric potential of a data signal Vsg to be supplied to an adjacent G data signal line. Each of G data and B data is data for a black display. Note here that, taking into consideration a pull-in phenomenon occurring after each data signal is written to a picture element, a waveform of an electric potential of the each data signal is often set so that its center of positive and negative peaks slightly deviates from a common electrode electric potential Vcom in a positive direction.

As is clear from FIG. 9(a), the electric potential Vd of the picture element electrode to which the R data signal Vsr having a positive polarity was written during a period of a gate pulse Vg changes, every time the polarity of the R data signal Vsr is reversed thereafter, via (i) parasitic capacitance between the picture element electrode of the subject picture element and a data signal line corresponding to the subject picture element and (ii) parasitic capacitance between the picture element electrode of the subject picture element and a data signal line corresponding to an adjacent picture element.

Assume that (i) an electric potential of a data signal having a positive polarity has a value falling within a range from a minimum value of Vmin+ to a maximum value of Vmax+ and (ii) an electric potential of a data signal having a negative polarity has a value falling within a range from a minimum value of Vmax− to a maximum value of Vmin−. Then, Vmax−<Vmin−<Vcom<Vmin+<Vmax+.

In a case of a normally black display, the electric potential of the R data signal Vsr largely deviates from the common electrode electric potential Vcom, as compared with those of the G data signal Vsg and B data signal Vsb each of which causes a black display. In this case, the electric potential of the data signal Vsr is Vmax+ when it is positive and Vmax− when it is negative. Further, the R data signal Vsr has a polarity reverse to that of the data signal Vsg of the data signal line corresponding to the adjacent picture element. The electric potential of the data signal Vsg is Vmin+ when it is positive and Vmin− when it is negative.

Accordingly, every time the R data signal Vsr is written to another picture element electrode in the same column, the electric potential Vd of the picture element electrode of the subject picture element changes, taken as a whole, as if it is pulled toward a polarity of an electric potential of the data signal Vsr written to the another picture element electrode. During a vertical blanking interval Tv, each data signal line retains an electric potential of the data signal Vsr for the last row, e.g., a data signal Vsr having a positive polarity. The polarity of the data signal Vsr for the last row is reversed for every one (1) frame.

Further, as is clear from FIG. 9(b), the electric potential Vd of the picture element electrode to which the R data signal Vsr having a negative polarity was written changes in the similar manner via parasitic capacitance, every time the polarity of the R data signal Vsr is reversed thereafter. During the vertical blanking interval Tv, each data signal line retains an electric potential of the data signal Vsr for the last row, e.g., a data signal Vsr having a positive polarity. The polarity of the data signal for the last row is reversed for every one (1) frame.

Note however that, according to FIG. 9(a), since the data signal Vsr for the last row has the positive polarity, the electric potential Vd of a picture element electrode, to which the data signal Vsr was written during writing for the last row, is to be increased. Therefore, if the each data signal line is caused to retain the data signal Vsr having the positive polarity during the vertical blanking interval Tv, the electric potential Vd of the picture element electrode, which potential has been increased by the writing for the last row, is to be retained during the vertical blanking interval Tv. This increases an effective value Vrms+ of a voltage applied to liquid crystal in the picture element to which the data signal Vsr having the positive polarity is written.

Further, according also to FIG. 9(b), since the data signal Vsr for the last row has the positive polarity, the electric potential Vd of the picture element electrode, to which the data signal Vsr was written during the writing for the last row, is to be increased. Therefore, if the each data signal line is caused to retain the data signal Vsr having the positive polarity during the vertical blanking interval Tv, the electric potential Vd of the picture element electrode, which potential has been increased by the writing for the last row, is to be retained during the vertical blanking interval Tv. This reduces an effective value Vrms− of a voltage applied to liquid crystal in the picture element to which the data signal Vsr having the negative polarity is written.

On the other hand, in a case where the data signal Vsr for the last row has a negative polarity, the effective value of the voltage applied to liquid crystal in the picture element to which the data signal Vsr having the positive polarity is written is reduced, whereas the effective value of the voltage applied to liquid crystal in the picture element to which the data signal Vsr having the negative polarity is written is increased.

In a case of a normally white display, a high-low relationship is reversed between electric potentials for white data and black data, i.e., (i) an electric potential of the data signal Vsr is Vmin+ when it is positive and Vmin− when it is negative and (ii) an electric potential of the data signal Vsg is Vmax+ when it is positive and Vmax− when it is negative. In such a case, every time the R data signal Vsr is written to another picture element electrode, the electric potential Vd of the picture element electrode of the subject picture element changes, taken as a whole, as if it is pulled toward a polarity of the electric potential of the data for the black display.

Accordingly, in the case of the normally white display, the following occurs. That is, in a case where the data signal Vsr for the last row has a positive polarity, (i) an effective value of a voltage applied to liquid crystal in a picture element to which the data signal Vsr having a positive polarity is written is reduced and (ii) an effective value of a voltage applied to liquid crystal in a picture element to which the data signal Vsr having a negative polarity is written is increased. On the other hand, in a case where the data signal Vsr for the last row has a negative polarity, (a) the effective value of the voltage applied to liquid crystal in the picture element to which the data signal Vsr having the positive polarity is written is increased and (b) the effective value of the voltage applied to liquid crystal in the picture element to which the data signal Vsr having the negative polarity is written is reduced.

As described above, according to a conventional liquid crystal display device which employs an AC driving in which (i) data signals having opposite polarities are written to respective picture elements adjacent to each other within the same row, (ii) a polarity of a data signal supplied to each data signal line is reversed at least once during one (1) vertical period, and (iii) a polarity of a data signal written to each picture element is reversed for every predetermined period (e.g., every one (1) frame period), the following occurs. That is, in a case where an image having a single color is displayed, an effective value of a voltage applied to liquid crystal largely differs between a picture element to which a data signal having a positive polarity is written and a picture element to which a data signal having a negative polarity is written. This causes a reduction in display quality, e.g., a horizontal line appears in a display screen.

The present invention has been made in view of the problem of the conventional technique, and an object of the present invention is to achieve a display device and a method for driving a display device in each of which, while an AC driving is carried out so that (i) data signals having opposite polarities are written to respective picture elements adjacent to each other within the same row, (ii) a polarity of a data signal supplied to each data signal line is reversed at least once during one (1) vertical period, and (iii) a polarity of a data signal written to each picture element is reversed for every predetermined period, an effective value of a voltage applied to liquid crystal is less likely to differ between a picture element to which a data signal having a positive polarity is written and a picture element to which a data signal having a negative polarity is written.

### Solution to Problem

In order to attain the above object, a display device in accordance with the present invention is an active matrix display device, including: picture elements; and data signal lines, the active matrix display device employing an AC driving in which (i) data signals having opposite polarities are written to respective adjacent ones, of the picture elements, which are adjacent to each other within a same row, (ii) a polarity of a data signal supplied to each of the data signal lines is reversed at least once during one (1) vertical period, and (iii) a polarity of a data signal written to each of the picture elements is reversed for every predetermined period,

during a vertical blanking interval, each of the data signal lines being supplied with a data signal for a gray display so as to retain the data signal for the gray display, the data signal for the gray display having a polarity identical to a polarity of a data signal supplied to said each of the data signal lines immediately before the vertical blanking interval.

According to the invention, in a case where a single color image is displayed, the following occurs at a start of the vertical blanking interval. That is, in a case of a normally black display, in a case where a data signal supplied to a picture element in the last row of one (1) frame has a positive polarity, an electric potential of a picture element electrode of a picture element (subject picture element) to which a data signal for the single color is written is (i) affected and reduced by, via parasitic capacitance between the picture element electrode of the subject picture element and a data signal line corresponding to the subject picture element, a change of an electric potential of the data signal line corresponding to the subject picture element to an electric potential for a gray display and (ii) affected and reduced by, via parasitic capacitance between the picture element electrode of the subject picture element and a data signal line corresponding to an adjacent picture element, a change of an electric potential of the data signal line corresponding to the adjacent picture element to an electric potential for a gray display. That is, the picture element electrode of the subject picture element undergoes a change in its electric potential so that the electric potential as a whole decreases. On the other hand, in a case where the data signal supplied to the picture element in the last row of one (1) frame has a negative polarity, the picture element electrode of the picture element undergoes a change in its electric potential so that the electric potential as a whole increases.

Accordingly, in a case where the data signal written to the picture element in the last row of one (1) frame has a positive polarity, an effective value of a positive voltage applied to liquid crystal in the subject picture element is smaller than that of a conventional technique, whereas an effective value of a negative voltage applied to liquid crystal in the subject picture element is larger than that of a conventional technique. On the other hand, in a case where the data signal written to the picture element in the last row of one (1) frame has a negative polarity, the effective value of the positive voltage applied to liquid crystal in the subject picture element is larger than that of a conventional technique, whereas the effective value of the negative voltage applied to liquid crystal in the subject picture element is smaller than that of a conventional technique. As a result, the effective value of the positive voltage applied to liquid crystal and the effective value of the negative voltage applied to liquid crystal are close to each other as compared to a conventional technique or are equal to each other.

On the other hand, in a case of a normally white display, the following occurs. That is, in a case where a data signal written to a picture element in the last row of one (1) frame has a positive polarity, an effective value of a voltage applied to liquid crystal in a subject picture element to which a positive data signal for the single color is written is larger than that of a conventional technique, whereas an effective value of a voltage applied to liquid crystal in a subject picture element to which a negative data signal for the single color is written is smaller than that of a conventional technique. On the other hand, in a case where the data signal written to the picture element in the last row of one (1) frame has a negative polarity, an effective value of a positive voltage applied to liquid crystal in the subject picture element is smaller than that of a conventional technique, whereas an effective value of a negative voltage applied to liquid crystal in the subject picture element is larger than that of a conventional technique. As a result, the effective value of the positive voltage applied to liquid crystal and the effective value of the negative voltage applied to liquid crystal are close to each other as compared to a conventional technique or are equal to each other.

Accordingly, it is possible to achieve a display device in which, while an AC driving is carried out so that (i) data signals having opposite polarities are written to respective picture elements adjacent to each other within the same row, (ii) a polarity of a data signal supplied to each data signal line is reversed at least once during one (1) vertical period, and (iii) a polarity of a data signal written to each picture element is reversed for every predetermined period, an effective value of a voltage applied to liquid crystal is less likely to differ between a picture element to which a data signal having a positive polarity is written and a picture element to which a data signal having a negative polarity is written.

In order to attain the above object, a display device in accordance with the present invention is an active matrix display device, including: picture elements; and data signal lines, the active matrix display device employing an AC driving in which (i) data signals having opposite polarities are written to respective adjacent ones, of the picture elements, which are adjacent to each other within a same row, (ii) a polarity of a data signal supplied to each of the data signal lines is reversed at least once during one (1) vertical period, and (iii) a polarity of a data signal written to each of the picture elements is reversed for every predetermined period,

during a vertical blanking interval, each of the data signal lines being supplied with a data signal for a gray display so as to retain the data signal for the gray display, the data signal for the gray display having a polarity reverse to a polarity of a data signal supplied to said each of the data signal lines immediately before the vertical blanking interval.

According to the invention, in a case where a single color image is displayed, the following occurs at a start of the vertical blanking interval. That is, in a case of a normally black display, in a case where a data signal supplied to a picture element in the last row of one (1) frame has a positive polarity, an electric potential of a picture element electrode of a picture element (subject picture element) to which a data signal for the single color is written is (i) affected and largely reduced by, via parasitic capacitance between the picture element electrode of the subject picture element and a data signal line corresponding to the subject picture element, a change of an electric potential of the data signal line corresponding to the subject picture element to an electric potential for a gray display and (ii) affected and slightly increased by, via parasitic capacitance between the picture element electrode of the subject picture element and a data signal line corresponding to an adjacent picture element, a change of an electric potential of the data signal line corresponding to the adjacent picture element to an electric potential for a gray display. That is, the picture element electrode of the subject picture element undergoes a change in its electric potential so that the electric potential as a whole decreases. On the other hand, in a case where the data signal supplied to the picture element in the last row of one (1) frame has a negative polarity, the picture element electrode of the picture element undergoes a change in its electric potential so that the electric potential as a whole increases.

Accordingly, in a case where the data signal written to the picture element in the last row of one (1) frame has a positive polarity, an effective value of a positive voltage applied to liquid crystal in the subject picture element is smaller than that of a conventional technique, whereas an effective value of a negative voltage applied to liquid crystal in the subject picture element is larger than that of a conventional technique. On the other hand, in a case where the data signal written to the picture element in the last row of one (1) frame has a negative polarity, the effective value of the positive voltage applied to liquid crystal in the subject picture element is larger than that of a conventional technique, whereas the effective value of the negative voltage applied to liquid crystal in the subject picture element is smaller than that of a conventional technique. As a result, the effective value of the positive voltage applied to liquid crystal and the effective value of the negative voltage applied to liquid crystal are close to each other as compared to a conventional technique or are equal to each other.

On the other hand, in a case of a normally white display, the following occurs. That is, in a case where a data signal written to a picture element in the last row of one (1) frame has a positive polarity, an effective value of a voltage applied to liquid crystal in a subject picture element to which a positive data signal for the single color is written is larger than that of a conventional technique, whereas an effective value of a voltage applied to liquid crystal in a subject picture element to which a negative data signal for the single color is written is smaller than that of a conventional technique. On the other hand, in a case where the data signal written to the picture element in the last row of one (1) frame has a negative polarity, an effective value of a positive voltage applied to liquid crystal in the subject picture element is smaller than that of a conventional technique, whereas an effective value of a negative voltage applied to liquid crystal in the subject picture element is larger than that of a conventional technique. As a result, the effective value of the positive voltage applied to liquid crystal and the effective value of the negative voltage applied to liquid crystal are close to each other as compared to a conventional technique or are equal to each other.

Accordingly, it is possible to achieve a display device in which, while an AC driving is carried out so that (i) data signals having opposite polarities are written to respective picture elements adjacent to each other within the same row, (ii) a polarity of a data signal supplied to each data signal line is reversed at least once during one (1) vertical period, and (iii) a polarity of a data signal written to each picture element is reversed for every predetermined period, an effective value of a voltage applied to liquid crystal is less likely to differ between a picture element to which a data signal having a positive polarity is written and a picture element to which a data signal having a negative polarity is written.

In order to attain the above object, a display device in accordance with the present invention is an active matrix display device, including: picture elements; and data signal lines, the active matrix display device employing an AC driving in which (i) data signals having opposite polarities are written to respective adjacent ones, of the picture elements, which are adjacent to each other within a same row, (ii) a polarity of a data signal supplied to each of the data signal lines is reversed at least once during one (1) vertical period, and (iii) a polarity of a data signal written to each of the picture elements is reversed for every predetermined period,

during a vertical blanking interval, each of the data signal lines being supplied with a data signal for a white display so as to retain the data signal for the white display, the data signal for the white display having a polarity identical to a polarity of a data signal supplied to said each of the data signal lines immediately before the vertical blanking interval.

According to the invention, in a case where a single color image is displayed, the following occurs at a start of the vertical blanking interval. That is, in a case of a normally black display, in a case where a data signal supplied to a picture element in the last row of one (1) frame has a positive polarity, an electric potential of a picture element electrode of a picture element (subject picture element) to which a data signal for the single color is written is (i) affected and reduced by, via parasitic capacitance between the picture element electrode of the subject picture element and a data signal line corresponding to the subject picture element, an electric potential of the data signal line corresponding to the subject picture element which electric potential remains the same and (ii) affected and reduced by, via parasitic capacitance between the picture element electrode of the subject picture element and a data signal line corresponding to an adjacent picture element, a change of an electric potential of the data signal line corresponding to the adjacent picture element to an electric potential for a white display. That is, the picture element electrode of the subject picture element undergoes a change in its electric potential so that the electric potential as a whole decreases. On the other hand, in a case where the data signal supplied to the picture element in the last row of one (1) frame has a negative polarity, the picture element electrode of the picture element undergoes a change in its electric potential so that the electric potential as a whole increases.

Accordingly, an effective value of a positive voltage applied to liquid crystal in the subject picture element is smaller than that of a conventional technique, whereas an effective value of a negative voltage applied to liquid crystal in the subject picture element is larger than that of a conventional technique. As a result, the effective value of the positive voltage applied to liquid crystal and the effective value of the negative voltage applied to liquid crystal are close to each other as compared to a conventional technique or are equal to each other.

On the other hand, in a case of a normally white display, the following occurs. That is, in a case where a data signal written to a picture element in the last row of one (1) frame has a positive polarity, an effective value of a voltage applied to liquid crystal in a subject picture element to which a positive data signal for the single color is written is larger than that of a conventional technique, whereas an effective value of a voltage applied to liquid crystal in a subject picture element to which a negative data signal for the single color is written is smaller than that of a conventional technique. On the other hand, in a case where the data signal written to the picture element in the last row of one (1) frame has a negative polarity, an effective value of a positive voltage applied to liquid crystal in the subject picture element is smaller than that of a conventional technique, whereas an effective value of a negative voltage applied to liquid crystal in the subject picture element is larger than that of a conventional technique. As a result, the effective value of the positive voltage applied to liquid crystal and the effective value of the negative voltage applied to liquid crystal are close to each other as compared to a conventional technique or are equal to each other.

Accordingly, it is possible to achieve a display device in which, while an AC driving is carried out so that (i) data signals having opposite polarities are written to respective picture elements adjacent to each other within the same row, (ii) a polarity of a data signal supplied to each data signal line is reversed at least once during one (1) vertical period, and (iii) a polarity of a data signal written to each picture element is reversed for every predetermined period, an effective value of a voltage applied to liquid crystal is less likely to differ between a picture element to which a data signal having a positive polarity is written and a picture element to which a data signal having a negative polarity is written.

In order to attain the above object, a display device in accordance with the present invention is an active matrix display device, including: picture elements; and data signal lines, the active matrix display device employing an AC driving in which (i) data signals having opposite polarities are written to respective adjacent ones, of the picture elements, which are adjacent to each other within a same row, (ii) a polarity of a data signal supplied to each of the data signal lines is reversed at least once during one (1) vertical period, and (iii) a polarity of a data signal written to each of the picture elements is reversed for every predetermined period,

during a vertical blanking interval, each of the data signal lines being supplied with a data signal for a white display so as to retain the data signal for the white display, the data signal for the white display having a polarity reverse to a polarity of a data signal supplied to said each of the data signal lines immediately before the vertical blanking interval.

According to the invention, in a case where a single color image is displayed, the following occurs at a start of the vertical blanking interval. That is, in a case of a normally black display, in a case where a data signal supplied to a picture element in the last row of one (1) frame has a positive polarity, an electric potential of a picture element electrode of a picture element (subject picture element) to which a data signal for the single color is written is (i) affected and largely reduced by, via parasitic capacitance between the picture element electrode of the subject picture element and a data signal line corresponding to the subject picture element, a change of an electric potential of the data signal line corresponding to the subject picture element to an electric potential for a white display and (ii) affected and slightly increased by, via parasitic capacitance between the picture element electrode of the subject picture element and a data signal line corresponding to an adjacent picture element, a change of an electric potential of the data signal line corresponding to the adjacent picture element to an electric potential for a white display. That is, the picture element electrode of the subject picture element undergoes a change in its electric potential so that the electric potential as a whole decreases. On the other hand, in a case where the data signal supplied to the picture element in the last row of one (1) frame has a negative polarity, the picture element electrode of the picture element undergoes a change in its electric potential so that the electric potential as a whole increases.

Accordingly, in a case where the data signal written to the picture element in the last row of one (1) frame has a positive polarity, an effective value of a positive voltage applied to liquid crystal in the subject picture element is smaller than that of a conventional technique, whereas an effective value of a negative voltage applied to liquid crystal in the subject picture element is larger than that of a conventional technique. On the other hand, in a case where the data signal written to the picture element in the last row of one (1) frame has a negative polarity, the effective value of the positive voltage applied to liquid crystal in the subject picture element is larger than that of a conventional technique, whereas the effective value of the negative voltage applied to liquid crystal in the subject picture element is smaller than that of a conventional technique. As a result, the effective value of the positive voltage applied to liquid crystal and the effective value of the negative voltage applied to liquid crystal are close to each other as compared to a conventional technique or are equal to each other.

On the other hand, in a case of a normally white display, the following occurs. That is, in a case where a data signal written to a picture element in the last row of one (1) frame has a positive polarity, an effective value of a voltage applied to liquid crystal in a subject picture element to which a positive data signal for the single color is written is larger than that of a conventional technique, whereas an effective value of a voltage applied to liquid crystal in a subject picture element to which a negative data signal for the single color is written is smaller than that of a conventional technique. On the other hand, in a case where the data signal written to the picture element in the last row of one (1) frame has a negative polarity, an effective value of a positive voltage applied to liquid crystal in the subject picture element is smaller than that of a conventional technique, whereas an effective value of a negative voltage applied to liquid crystal in the subject picture element is larger than that of a conventional technique. As a result, the effective value of the positive voltage applied to liquid crystal and the effective value of the negative voltage applied to liquid crystal are close to each other as compared to a conventional technique or are equal to each other.

Accordingly, it is possible to achieve a display device in which, while an AC driving is carried out so that (i) data signals having opposite polarities are written to respective picture elements adjacent to each other within the same row, (ii) a polarity of a data signal supplied to each data signal line is reversed at least once during one (1) vertical period, and (iii) a polarity of a data signal written to each picture element is reversed for every predetermined period, an effective value of a voltage applied to liquid crystal is less likely to differ between a picture element to which a data signal having a positive polarity is written and a picture element to which a data signal having a negative polarity is written.

In order to attain the above object, a display device in accordance with the present invention is an active matrix display device, including: picture elements; and data signal lines, the active matrix display device employing an AC driving in which (i) data signals having opposite polarities are written to respective adjacent ones, of the picture elements, which are adjacent to each other within a same row, (ii) a polarity of a data signal supplied to each of the data signal lines is reversed at least once during one (1) vertical period, and (iii) a polarity of a data signal written to each of the picture elements is reversed for every predetermined period,

during a vertical blanking interval, each of the data signal lines being supplied with a data signal for a black display so as to retain the data signal for the black display, the data signal for the black display having a polarity identical to a polarity of a data signal supplied to said each of the data signal lines immediately before the vertical blanking interval.

According to the invention, in a case where a single color image is displayed, the following occurs at a start of the vertical blanking interval. That is, in a case of a normally black display, in a case where a data signal supplied to a picture element in the last row of one (1) frame has a positive polarity, an electric potential of a picture element electrode of a picture element (subject picture element) to which a data signal for the single color is written (i) is affected and reduced by, via parasitic capacitance between the picture element electrode of the subject picture element and a data signal line corresponding to the subject picture element, a change of an electric potential of the data signal line corresponding to the subject picture element to an electric potential for a black display and (ii) receives no affection via parasitic capacitance between the picture element electrode of the subject picture element and a data signal line corresponding to an adjacent picture element because there is no change in an electric potential of the data signal line corresponding to the adjacent picture element. That is, the picture element electrode of the subject picture element undergoes a change in its electric potential so that the electric potential as a whole decreases. On the other hand, in a case where the data signal supplied to the picture element in the last row of one (1) frame has a negative polarity, the picture element electrode of the picture element undergoes a change in its electric potential so that the electric potential as a whole increases.

Accordingly, an effective value of a positive voltage applied to liquid crystal in the subject picture element is smaller than that of a conventional technique, whereas an effective value of a negative voltage applied to liquid crystal in the subject picture element is larger than that of a conventional technique. As a result, the effective value of the positive voltage applied to liquid crystal and the effective value of the negative voltage applied to liquid crystal are close to each other as compared to a conventional technique or are equal to each other.

On the other hand, in a case of a normally white display, the following occurs. That is, in a case where a data signal written to a picture element in the last row of one (1) frame has a positive polarity, an effective value of a voltage applied to liquid crystal in a subject picture element to which a positive data signal for the single color is written is larger than that of a conventional technique, whereas an effective value of a voltage applied to liquid crystal in a subject picture element to which a negative data signal for the single color is written is smaller than that of a conventional technique. On the other hand, in a case where the data signal written to the picture element in the last row of one (1) frame has a negative polarity, an effective value of a positive voltage applied to liquid crystal in the subject picture element is smaller than that of a conventional technique, whereas an effective value of a negative voltage applied to liquid crystal in the subject picture element is larger than that of a conventional technique. As a result, the effective value of the positive voltage applied to liquid crystal and the effective value of the negative voltage applied to liquid crystal are close to each other as compared to a conventional technique or are equal to each other.

Accordingly, it is possible to achieve a display device in which, while an AC driving is carried out so that (i) data signals having opposite polarities are written to respective picture elements adjacent to each other within the same row, (ii) a polarity of a data signal supplied to each data signal line is reversed at least once during one (1) vertical period, and (iii) a polarity of a data signal written to each picture element is reversed for every predetermined period, an effective value of a voltage applied to liquid crystal is less likely to differ between a picture element to which a data signal having a positive polarity is written and a picture element to which a data signal having a negative polarity is written.

In order to attain the above object, a display device in accordance with the present invention is an active matrix display device, including: picture elements; and data signal lines, the active matrix display device employing an AC driving in which (i) data signals having opposite polarities are written to respective adjacent ones, of the picture elements, which are adjacent to each other within a same row, (ii) a polarity of a data signal supplied to each of the data signal lines is reversed at least once during one (1) vertical period, and (iii) a polarity of a data signal written to each of the picture elements is reversed for every predetermined period,

during a vertical blanking interval, each of the data signal lines being supplied with a data signal for a black display so as to retain the data signal for the black display, the data signal for the black display having a polarity reverse to a polarity of a data signal supplied to said each of the data signal lines immediately before the vertical blanking interval.

According to the invention, in a case where a single color image is displayed, the following occurs at a start of the vertical blanking interval. That is, in a case of a normally black display, in a case where a data signal supplied to a picture element in the last row of one (1) frame has a positive polarity, an electric potential of a picture element electrode of a picture element (subject picture element) to which a data signal for the single color is written is (i) affected and largely reduced by, via parasitic capacitance between the picture element electrode of the subject picture element and a data signal line corresponding to the subject picture element, a change of an electric potential of the data signal line corresponding to the subject picture element to an electric potential for a black display and (ii) affected and slightly increased by, via parasitic capacitance between the picture element electrode of the subject picture element and a data signal line corresponding to an adjacent picture element, a change of an electric potential of the data signal line corresponding to the adjacent picture element to an electric potential for a black display. That is, the picture element electrode of the subject picture element undergoes a change in its electric potential so that the electric potential as a whole decreases. On the other hand, in a case where the data signal supplied to the picture element in the last row of one (1) frame has a negative polarity, the picture element electrode of the picture element undergoes a change in its electric potential so that the electric potential as a whole increases.

Accordingly, in a case where the data signal written to the picture element in the last row of one (1) frame has a positive polarity, an effective value of a positive voltage applied to liquid crystal in the subject picture element is smaller than that of a conventional technique, whereas an effective value of a negative voltage applied to liquid crystal in the subject picture element is larger than that of a conventional technique. On the other hand, in a case where the data signal written to the picture element in the last row of one (1) frame has a negative polarity, the effective value of the positive voltage applied to liquid crystal in the subject picture element is larger than that of a conventional technique, whereas the effective value of the negative voltage applied to liquid crystal in the subject picture element is smaller than that of a conventional technique. As a result, the effective value of the positive voltage applied to liquid crystal and the effective value of the negative voltage applied to liquid crystal are close to each other as compared to a conventional technique or are equal to each other.

On the other hand, in a case of a normally white display, the following occurs. That is, in a case where a data signal written to a picture element in the last row of one (1) frame has a positive polarity, an effective value of a voltage applied to liquid crystal in a subject picture element to which a positive data signal for the single color is written is larger than that of a conventional technique, whereas an effective value of a voltage applied to liquid crystal in a subject picture element to which a negative data signal for the single color is written is smaller than that of a conventional technique. On the other hand, in a case where the data signal written to the picture element in the last row of one (1) frame has a negative polarity, an effective value of a positive voltage applied to liquid crystal in the subject picture element is smaller than that of a conventional technique, whereas an effective value of a negative voltage applied to liquid crystal in the subject picture element is larger than that of a conventional technique. As a result, the effective value of the positive voltage applied to liquid crystal and the effective value of the negative voltage applied to liquid crystal are close to each other as compared to a conventional technique or are equal to each other.

Accordingly, it is possible to achieve a display device in which, while an AC driving is carried out so that (i) data signals having opposite polarities are written to respective picture elements adjacent to each other within the same row, (ii) a polarity of a data signal supplied to each data signal line is reversed at least once during one (1) vertical period, and (iii) a polarity of a data signal written to each picture element is reversed for every predetermined period, an effective value of a voltage applied to liquid crystal is less likely to differ between a picture element to which a data signal having a positive polarity is written and a picture element to which a data signal having a negative polarity is written.

In order to attain the above object, a method for driving a display device in accordance with the present invention is a method for driving an active matrix display device, the active matrix display device (i) including picture elements and data signal lines and (ii) employing an AC driving in which (a) data signals having opposite polarities are written to respective adjacent ones, of the picture elements, which are adjacent to each other within a same row, (b) a polarity of a data signal supplied to each of the data signal lines is reversed at least once during one (1) vertical period, and (c) a polarity of a data signal written to each of the picture elements is reversed for every predetermined period,

said method, including the step of: supplying, during a vertical blanking interval, a data signal for a gray display to each of the data signal lines so as to cause said each of the data signal lines to retain the data signal for the gray display, the data signal for the gray display having a polarity identical to a polarity of a data signal supplied to said each of the data signal lines immediately before the vertical blanking interval.

According to the invention, in a case where a single color image is displayed, the following occurs at a start of the vertical blanking interval. That is, in a case of a normally black display, in a case where a data signal supplied to a picture element in the last row of one (1) frame has a positive polarity, an electric potential of a picture element electrode of a picture element (subject picture element) to which a data signal for the single color is written is (i) affected and reduced by, via parasitic capacitance between the picture element electrode of the subject picture element and a data signal line corresponding to the subject picture element, a change of an electric potential of the data signal line corresponding to the subject picture element to an electric potential for a gray display and (ii) affected and reduced by, via parasitic capacitance between the picture element electrode of the subject picture element and a data signal line corresponding to an adjacent picture element, a change of an electric potential of the data signal line corresponding to the adjacent picture element to an electric potential for a gray display. That is, the picture element electrode of the subject picture element undergoes a change in its electric potential so that the electric potential as a whole decreases. On the other hand, in a case where the data signal supplied to the picture element in the last row of one (1) frame has a negative polarity, the picture element electrode of the picture element undergoes a change in its electric potential so that the electric potential as a whole increases.

Accordingly, in a case where the data signal written to the picture element in the last row of one (1) frame has a positive polarity, an effective value of a positive voltage applied to liquid crystal in the subject picture element is smaller than that of a conventional technique, whereas an effective value of a negative voltage applied to liquid crystal in the subject picture element is larger than that of a conventional technique. On the other hand, in a case where the data signal written to the picture element in the last row of one (1) frame has a negative polarity, the effective value of the positive voltage applied to liquid crystal in the subject picture element is larger than that of a conventional technique, whereas the effective value of the negative voltage applied to liquid crystal in the subject picture element is smaller than that of a conventional technique. As a result, the effective value of the positive voltage applied to liquid crystal and the effective value of the negative voltage applied to liquid crystal are close to each other as compared to a conventional technique or are equal to each other.

On the other hand, in a case of a normally white display, the following occurs. That is, in a case where a data signal written to a picture element in the last row of one (1) frame has a positive polarity, an effective value of a voltage applied to liquid crystal in a subject picture element to which a positive data signal for the single color is written is larger than that of a conventional technique, whereas an effective value of a voltage applied to liquid crystal in a subject picture element to which a negative data signal for the single color is written is smaller than that of a conventional technique. On the other hand, in a case where the data signal written to the picture element in the last row of one (1) frame has a negative polarity, an effective value of a positive voltage applied to liquid crystal in the subject picture element is smaller than that of a conventional technique, whereas an effective value of a negative voltage applied to liquid crystal in the subject picture element is larger than that of a conventional technique. As a result, the effective value of the positive voltage applied to liquid crystal and the effective value of the negative voltage applied to liquid crystal are close to each other as compared to a conventional technique or are equal to each other.

Accordingly, it is possible to achieve a method for driving a display device in which, while an AC driving is carried out so that (i) data signals having opposite polarities are written to respective picture elements adjacent to each other within the same row, (ii) a polarity of a data signal supplied to each data signal line is reversed at least once during one (1) vertical period, and (iii) a polarity of a data signal written to each picture element is reversed for every predetermined period, an effective value of a voltage applied to liquid crystal is less likely to differ between a picture element to which a data signal having a positive polarity is written and a picture element to which a data signal having a negative polarity is written.

In order to attain the above object, a method for diving a display device in accordance with the present invention is a method for driving an active matrix display device, the active matrix display device (i) including picture elements and data signal lines and (ii) employing an AC driving in which (a) data signals having opposite polarities are written to respective adjacent ones, of the picture elements, which are adjacent to each other within a same row, (b) a polarity of a data signal supplied to each of the data signal lines is reversed at least once during one (1) vertical period, and (c) a polarity of a data signal written to each of the picture elements is reversed for every predetermined period,

said method, including the step of: supplying, during a vertical blanking interval, a data signal for a gray display to each of the data signal lines so as to cause said each of the data signal lines to retain the data signal for the gray display, the data signal for the gray display having a polarity reverse to a polarity of a data signal supplied to said each of the data signal lines immediately before the vertical blanking interval.

According to the invention, in a case where a single color image is displayed, the following occurs at a start of the vertical blanking interval. That is, in a case of a normally black display, in a case where a data signal supplied to a picture element in the last row of one (1) frame has a positive polarity, an electric potential of a picture element electrode of a picture element (subject picture element) to which a data signal for the single color is written is (i) affected and largely reduced by, via parasitic capacitance between the picture element electrode of the subject picture element and a data signal line corresponding to the subject picture element, a change of an electric potential of the data signal line corresponding to the subject picture element to an electric potential for a gray display and (ii) affected and slightly increased by, via parasitic capacitance between the picture element electrode of the subject picture element and a data signal line corresponding to an adjacent picture element, a change of an electric potential of the data signal line corresponding to the adjacent picture element to an electric potential for a gray display. That is, the picture element electrode of the subject picture element undergoes a change in its electric potential so that the electric potential as a whole decreases. On the other hand, in a case where the data signal supplied to the picture element in the last row of one (1) frame has a negative polarity, the picture element electrode of the picture element undergoes a change in its electric potential so that the electric potential as a whole increases.

Accordingly, in a case where the data signal written to the picture element in the last row of one (1) frame has a positive polarity, an effective value of a positive voltage applied to liquid crystal in the subject picture element is smaller than that of a conventional technique, whereas an effective value of a negative voltage applied to liquid crystal in the subject picture element is larger than that of a conventional technique. On the other hand, in a case where the data signal written to the picture element in the last row of one (1) frame has a negative polarity, the effective value of the positive voltage applied to liquid crystal in the subject picture element is larger than that of a conventional technique, whereas the effective value of the negative voltage applied to liquid crystal in the subject picture element is smaller than that of a conventional technique. As a result, the effective value of the positive voltage applied to liquid crystal and the effective value of the negative voltage applied to liquid crystal are close to each other as compared to a conventional technique or are equal to each other.

On the other hand, in a case of a normally white display, the following occurs. That is, in a case where a data signal written to a picture element in the last row of one (1) frame has a positive polarity, an effective value of a voltage applied to liquid crystal in a subject picture element to which a positive data signal for the single color is written is larger than that of a conventional technique, whereas an effective value of a voltage applied to liquid crystal in a subject picture element to which a negative data signal for the single color is written is smaller than that of a conventional technique. On the other hand, in a case where the data signal written to the picture element in the last row of one (1) frame has a negative polarity, an effective value of a positive voltage applied to liquid crystal in the subject picture element is smaller than that of a conventional technique, whereas an effective value of a negative voltage applied to liquid crystal in the subject picture element is larger than that of a conventional technique. As a result, the effective value of the positive voltage applied to liquid crystal and the effective value of the negative voltage applied to liquid crystal are close to each other as compared to a conventional technique or are equal to each other.

Accordingly, it is possible to achieve a method for driving a display device in which, while an AC driving is carried out so that (i) data signals having opposite polarities are written to respective picture elements adjacent to each other within the same row, (ii) a polarity of a data signal supplied to each data signal line is reversed at least once during one (1) vertical period, and (iii) a polarity of a data signal written to each picture element is reversed for every predetermined period, an effective value of a voltage applied to liquid crystal is less likely to differ between a picture element to which a data signal having a positive polarity is written and a picture element to which a data signal having a negative polarity is written.

In order to attain the above object, a method for driving a display device in accordance with the present invention is a method for driving an active matrix display device, the active matrix display device (i) including picture elements and data signal lines and (ii) employing an AC driving in which (a) data signals having opposite polarities are written to respective adjacent ones, of the picture elements, which are adjacent to each other within a same row, (b) a polarity of a data signal supplied to each of the data signal lines is reversed at least once during one (1) vertical period, and (c) a polarity of a data signal written to each of the picture elements is reversed for every predetermined period,

said method, including the step of: supplying, during a vertical blanking interval, a data signal for a white display to each of the data signal lines so as to cause said each of the data signal lines to retain the data signal for the white display, the data signal for the white display having a polarity identical to a polarity of a data signal supplied to said each of the data signal lines immediately before the vertical blanking interval.

According to the invention, in a case where a single color image is displayed, the following occurs at a start of the vertical blanking interval. That is, in a case of a normally black display, in a case where a data signal supplied to a picture element in the last row of one (1) frame has a positive polarity, an electric potential of a picture element electrode of a picture element (subject picture element) to which a data signal for the single color is written is (i) affected and reduced by, via parasitic capacitance between the picture element electrode of the subject picture element and a data signal line corresponding to the subject picture element, an electric potential of the data signal line corresponding to the subject picture element which electric potential remains the same and (ii) affected and reduced by, via parasitic capacitance between the picture element electrode of the subject picture element and a data signal line corresponding to an adjacent picture element, a change of an electric potential of the data signal line corresponding to the adjacent picture element to an electric potential for a white display. That is, the picture element electrode of the subject picture element undergoes a change in its electric potential so that the electric potential as a whole decreases. On the other hand, in a case where the data signal supplied to the picture element in the last row of one (1) frame has a negative polarity, the picture element electrode of the picture element undergoes a change in its electric potential so that the electric potential as a whole increases.

Accordingly, an effective value of a positive voltage applied to liquid crystal in the subject picture element is smaller than that of a conventional technique, whereas an effective value of a negative voltage applied to liquid crystal in the subject picture element is larger than that of a conventional technique. As a result, the effective value of the positive voltage applied to liquid crystal and the effective value of the negative voltage applied to liquid crystal are close to each other as compared to a conventional technique or are equal to each other.

On the other hand, in a case of a normally white display, the following occurs. That is, in a case where a data signal written to a picture element in the last row of one (1) frame has a positive polarity, an effective value of a voltage applied to liquid crystal in a subject picture element to which a positive data signal for the single color is written is larger than that of a conventional technique, whereas an effective value of a voltage applied to liquid crystal in a subject picture element to which a negative data signal for the single color is written is smaller than that of a conventional technique. On the other hand, in a case where the data signal written to the picture element in the last row of one (1) frame has a negative polarity, an effective value of a positive voltage applied to liquid crystal in the subject picture element is smaller than that of a conventional technique, whereas an effective value of a negative voltage applied to liquid crystal in the subject picture element is larger than that of a conventional technique. As a result, the effective value of the positive voltage applied to liquid crystal and the effective value of the negative voltage applied to liquid crystal are close to each other as compared to a conventional technique or are equal to each other.

Accordingly, it is possible to achieve a method for driving a display device in which, while an AC driving is carried out so that (i) data signals having opposite polarities are written to respective picture elements adjacent to each other within the same row, (ii) a polarity of a data signal supplied to each data signal line is reversed at least once during one (1) vertical period, and (iii) a polarity of a data signal written to each picture element is reversed for every predetermined period, an effective value of a voltage applied to liquid crystal is less likely to differ between a picture element to which a data signal having a positive polarity is written and a picture element to which a data signal having a negative polarity is written.

In order to attain the above object, a method for driving a display device in accordance with the present invention is a method for driving an active matrix display device, the active matrix display device (i) including picture elements and data signal lines and (ii) employing an AC driving in which (a) data signals having opposite polarities are written to respective adjacent ones, of the picture elements, which are adjacent to each other within a same row, (b) a polarity of a data signal supplied to each of the data signal lines is reversed at least once during one (1) vertical period, and (c) a polarity of a data signal written to each of the picture elements is reversed for every predetermined period,

said method, including the step of: supplying, during a vertical blanking interval, a data signal for a white display to each of the data signal lines so as to cause said each of the data signal lines to retain the data signal for the white display, the data signal for the white display having a polarity reverse to a polarity of a data signal supplied to said each of the data signal lines immediately before the vertical blanking interval.

According to the invention, in a case where a single color image is displayed, the following occurs at a start of the vertical blanking interval. That is, in a case of a normally black display, in a case where a data signal supplied to a picture element in the last row of one (1) frame has a positive polarity, an electric potential of a picture element electrode of a picture element (subject picture element) to which a data signal for the single color is written is (i) affected and largely reduced by, via parasitic capacitance between the picture element electrode of the subject picture element and a data signal line corresponding to the subject picture element, a change of an electric potential of the data signal line corresponding to the subject picture element to an electric potential for a white display and (ii) affected and slightly increased by, via parasitic capacitance between the picture element electrode of the subject picture element and a data signal line corresponding to an adjacent picture element, a change of an electric potential of the data signal line corresponding to the adjacent picture element to an electric potential for a white display. That is, the picture element electrode of the subject picture element undergoes a change in its electric potential so that the electric potential as a whole decreases. On the other hand, in a case where the data signal supplied to the picture element in the last row of one (1) frame has a negative polarity, the picture element electrode of the picture element undergoes a change in its electric potential so that the electric potential as a whole increases.

Accordingly, in a case where the data signal written to the picture element in the last row of one (1) frame has a positive polarity, an effective value of a positive voltage applied to liquid crystal in the subject picture element is smaller than that of a conventional technique, whereas an effective value of a negative voltage applied to liquid crystal in the subject picture element is larger than that of a conventional technique. On the other hand, in a case where the data signal written to the picture element in the last row of one (1) frame has a negative polarity, the effective value of the positive voltage applied to liquid crystal in the subject picture element is larger than that of a conventional technique, whereas the effective value of the negative voltage applied to liquid crystal in the subject picture element is smaller than that of a conventional technique. As a result, the effective value of the positive voltage applied to liquid crystal and the effective value of the negative voltage applied to liquid crystal are close to each other as compared to a conventional technique or are equal to each other.

On the other hand, in a case of a normally white display, the following occurs. That is, in a case where a data signal written to a picture element in the last row of one (1) frame has a positive polarity, an effective value of a voltage applied to liquid crystal in a subject picture element to which a positive data signal for the single color is written is larger than that of a conventional technique, whereas an effective value of a voltage applied to liquid crystal in a subject picture element to which a negative data signal for the single color is written is smaller than that of a conventional technique. On the other hand, in a case where the data signal written to the picture element in the last row of one (1) frame has a negative polarity, an effective value of a positive voltage applied to liquid crystal in the subject picture element is smaller than that of a conventional technique, whereas an effective value of a negative voltage applied to liquid crystal in the subject picture element is larger than that of a conventional technique. As a result, the effective value of the positive voltage applied to liquid crystal and the effective value of the negative voltage applied to liquid crystal are close to each other as compared to a conventional technique or are equal to each other.

Accordingly, it is possible to achieve a method for driving a display device in which, while an AC driving is carried out so that (i) data signals having opposite polarities are written to respective picture elements adjacent to each other within the same row, (ii) a polarity of a data signal supplied to each data signal line is reversed at least once during one (1) vertical period, and (iii) a polarity of a data signal written to each picture element is reversed for every predetermined period, an effective value of a voltage applied to liquid crystal is less likely to differ between a picture element to which a data signal having a positive polarity is written and a picture element to which a data signal having a negative polarity is written.

In order to attain the above object, a method for driving a display device in accordance with the present invention is a method for driving an active matrix display device, the active matrix display device (i) including picture elements and data signal lines and (ii) employing an AC driving in which (a) data signals having opposite polarities are written to respective adjacent ones, of the picture elements, which are adjacent to each other within a same row, (b) a polarity of a data signal supplied to each of the data signal lines is reversed at least once during one (1) vertical period, and (c) a polarity of a data signal written to each of the picture elements is reversed for every predetermined period,

said method, including the step of: supplying, during a vertical blanking interval, a data signal for a black display to each of the data signal lines so as to cause said each of the data signal lines to retain the data signal for the black display, the data signal for the black display having a polarity identical to a polarity of a data signal supplied to said each of the data signal lines immediately before the vertical blanking interval.

According to the invention, in a case where a single color image is displayed, the following occurs at a start of the vertical blanking interval. That is, in a case of a normally black display, in a case where a data signal supplied to a picture element in the last row of one (1) frame has a positive polarity, an electric potential of a picture element electrode of a picture element (subject picture element) to which a data signal for the single color is written (i) is affected and reduced by, via parasitic capacitance between the picture element electrode of the subject picture element and a data signal line corresponding to the subject picture element, a change of an electric potential of the data signal line corresponding to the subject picture element to an electric potential for a black display and (ii) receives no affection via parasitic capacitance between the picture element electrode of the subject picture element and a data signal line corresponding to an adjacent picture element because there is no change in an electric potential of the data signal line corresponding to the adjacent picture element. That is, the picture element electrode of the subject picture element undergoes a change in its electric potential so that the electric potential as a whole decreases. On the other hand, in a case where the data signal supplied to the picture element in the last row of one (1) frame has a negative polarity, the picture element electrode of the picture element undergoes a change in its electric potential so that the electric potential as a whole increases.

Accordingly, an effective value of a positive voltage applied to liquid crystal in the subject picture element is smaller than that of a conventional technique, whereas an effective value of a negative voltage applied to liquid crystal in the subject picture element is larger than that of a conventional technique. As a result, the effective value of the positive voltage applied to liquid crystal and the effective value of the negative voltage applied to liquid crystal are close to each other as compared to a conventional technique or are equal to each other.

On the other hand, in a case of a normally white display, the following occurs. That is, in a case where a data signal written to a picture element in the last row of one (1) frame has a positive polarity, an effective value of a voltage applied to liquid crystal in a subject picture element to which a positive data signal for the single color is written is larger than that of a conventional technique, whereas an effective value of a voltage applied to liquid crystal in a subject picture element to which a negative data signal for the single color is written is smaller than that of a conventional technique. On the other hand, in a case where the data signal written to the picture element in the last row of one (1) frame has a negative polarity, an effective value of a positive voltage applied to liquid crystal in the subject picture element is smaller than that of a conventional technique, whereas an effective value of a negative voltage applied to liquid crystal in the subject picture element is larger than that of a conventional technique. As a result, the effective value of the positive voltage applied to liquid crystal and the effective value of the negative voltage applied to liquid crystal are close to each other as compared to a conventional technique or are equal to each other.

Accordingly, it is possible to achieve a method for driving a display device in which, while an AC driving is carried out so that (i) data signals having opposite polarities are written to respective picture elements adjacent to each other within the same row, (ii) a polarity of a data signal supplied to each data signal line is reversed at least once during one (1) vertical period, and (iii) a polarity of a data signal written to each picture element is reversed for every predetermined period, an effective value of a voltage applied to liquid crystal is less likely to differ between a picture element to which a data signal having a positive polarity is written and a picture element to which a data signal having a negative polarity is written.

In order to attain the above object, a method for driving a display device in accordance with the present invention is a method for driving an active matrix display device, the active matrix display device (i) including picture elements and data signal lines and (ii) employing an AC driving in which (a) data signals having opposite polarities are written to respective adjacent ones, of the picture elements, which are adjacent to each other within a same row, (b) a polarity of a data signal supplied to each of the data signal lines is reversed at least once during one (1) vertical period, and (c) a polarity of a data signal written to each of the picture elements is reversed for every predetermined period,

said method, including the step of: supplying, during a vertical blanking interval, a data signal for a black display to each of the data signal lines so as to cause said each of the data signal lines to retain the data signal for the black display, the data signal for the black display having a polarity reverse to a polarity of a data signal supplied to said each of the data signal lines immediately before the vertical blanking interval.

According to the invention, in a case where a single color image is displayed, the following occurs at a start of the vertical blanking interval. That is, in a case of a normally black display, in a case where a data signal supplied to a picture element in the last row of one (1) frame has a positive polarity, an electric potential of a pictuie element electrode of a picture element (subject picture element) to which a data signal for the single color is written is (i) affected and largely reduced by, via parasitic capacitance between the picture element electrode of the subject picture element and a data signal line corresponding to the subject picture element, a change of an electric potential of the data signal line corresponding to the subject picture element to an electric potential for a black display and (ii) affected and slightly increased by, via parasitic capacitance between the picture element electrode of the subject picture element and a data signal line corresponding to an adjacent picture element, a change of an electric potential of the data signal line corresponding to the adjacent picture element to an electric potential for a black display. That is, the picture element electrode of the subject picture element undergoes a change in its electric potential so that the electric potential as a whole decreases. On the other hand, in a case where the data signal supplied to the picture element in the last row of one (1) frame has a negative polarity, the picture element electrode of the picture element undergoes a change in its electric potential so that the electric potential as a whole increases.

Accordingly, in a case where the data signal written to the picture element in the last row of one (1) frame has a positive polarity, an effective value of a positive voltage applied to liquid crystal in the subject picture element is smaller than that of a conventional technique, whereas an effective value of a negative voltage applied to liquid crystal in the subject picture element is larger than that of a conventional technique. On the other hand, in a case where the data signal written to the picture element in the last row of one (1) frame has a negative polarity, the effective value of the positive voltage applied to liquid crystal in the subject picture element is larger than that of a conventional technique, whereas the effective value of the negative voltage applied to liquid crystal in the subject picture element is smaller than that of a conventional technique. As a result, the effective value of the positive voltage applied to liquid crystal and the effective value of the negative voltage applied to liquid crystal are close to each other as compared to a conventional technique or are equal to each other.

On the other hand, in a case of a normally white display, the following occurs. That is, in a case where a data signal written to a picture element in the last row of one (1) frame has a positive polarity, an effective value of a voltage applied to liquid crystal in a subject picture element to which a positive data signal for the single color is written is larger than that of a conventional technique, whereas an effective value of a voltage applied to liquid crystal in a subject picture element to which a negative data signal for the single color is written is smaller than that of a conventional technique. On the other hand, in a case where the data signal written to the picture element in the last row of one (1) frame has a negative polarity, an effective value of a positive voltage applied to liquid crystal in the subject picture element is smaller than that of a conventional technique, whereas an effective value of a negative voltage applied to liquid crystal in the subject picture element is larger than that of a conventional technique. As a result, the effective value of the positive voltage applied to liquid crystal and the effective value of the negative voltage applied to liquid crystal are close to each other as compared to a conventional technique or are equal to each other.

Accordingly, it is possible to achieve a method for driving a display device in which, while an AC driving is carried out so that (i) data signals having opposite polarities are written to respective picture elements adjacent to each other within the same row, (ii) a polarity of a data signal supplied to each data signal line is reversed at least once during one (1) vertical period, and (iii) a polarity of a data signal written to each picture element is reversed for every predetermined period, an effective value of a voltage applied to liquid crystal is less likely to differ between a picture element to which a data signal having a positive polarity is written and a picture element to which a data signal having a negative polarity is written.

### Advantageous Effects of Invention

As has been described, a display device in accordance with the present invention is an active matrix display device, including: picture elements; and data signal lines, the active matrix display device employing an AC driving in which (i) data signals having opposite polarities are written to respective adjacent ones, of the picture elements, which are adjacent to each other within a same row, (ii) a polarity of a data signal supplied to each of the data signal lines is reversed at least once during one (1) vertical period, and (iii) a polarity of a data signal written to each of the picture elements is reversed for every one (1) frame period,

during a vertical blanking interval, each of the data signal lines being supplied with a data signal for a gray display so as to retain the data signal for the gray display, the data signal for the gray display having a polarity identical to a polarity of a data signal supplied to said each of the data signal lines immediately before the vertical blanking interval.

Alternatively, as has been described, a display device in accordance with the present invention is an active matrix display device, including: picture elements; and data signal lines, the active matrix display device employing an AC driving in which (i) data signals having opposite polarities are written to respective adjacent ones, of the picture elements, which are adjacent to each other within a same row, (ii) a polarity of a data signal supplied to each of the data signal lines is reversed at least once during one (1) vertical period, and (iii) a polarity of a data signal written to each of the picture elements is reversed for every predetermined period,

during a vertical blanking interval, each of the data signal lines being supplied with a data signal for a gray display so as to retain the data signal for the gray display, the data signal for the gray display having a polarity reverse to a polarity of a data signal supplied to said each of the data signal lines immediately before the vertical blanking interval.

Accordingly, it is possible to achieve a display device in which, while an AC driving is carried out so that (i) data signals having opposite polarities are written to respective picture elements adjacent to each other within the same row, (ii) a polarity of a data signal supplied to each data signal line is reversed at least once during one (1) vertical period, and (iii) a polarity of a data signal written to each picture element is reversed for every predetermined period, an effective value of a voltage applied to liquid crystal is less likely to differ between a picture element to which a data signal having a positive polarity is written and a picture element to which a data signal having a negative polarity is written.

As has been described, a method for driving a display device in accordance with the present invention is a method for driving an active matrix display device, the active matrix display device (i) including picture elements and data signal lines and (ii) employing an AC driving in which (a) data signals having opposite polarities are written to respective adjacent ones, of the picture elements, which are adjacent to each other within a same row, (b) a polarity of a data signal supplied to each of the data signal lines is reversed at least once during one (1) vertical period, and (c) a polarity of a data signal written to each of the picture elements is reversed for every one (1) frame period, said method, including the step of: supplying, during a vertical blanking interval, a data signal for a gray display to each of the data signal lines so as to cause said each of the data signal lines to retain the data signal for the gray display, the data signal for the gray display having a polarity identical to a polarity of a data signal supplied to said each of the data signal lines immediately before the vertical blanking interval.

Alternatively, as has been described, a method for driving a display device in accordance with the present invention is a method for driving an active matrix display device, the active matrix display device (i) including picture elements and data signal lines and (ii) employing an AC driving in which (a) data signals having opposite polarities are written to respective adjacent ones, of the picture elements, which are adjacent to each other within a same row, (b) a polarity of a data signal supplied to each of the data signal lines is reversed at least once during one (1) vertical period, and (c) a polarity of a data signal written to each of the picture elements is reversed for every predetermined period,

said method, including the step of: supplying, during a vertical blanking interval, a data signal for a gray display to each of the data signal lines so as to cause said each of the data signal lines to retain the data signal for the gray display, the data signal for the gray display having a polarity reverse to a polarity of a data signal supplied to said each of the data signal lines immediately before the vertical blanking interval.

Accordingly, it is possible to achieve a method for driving a display device in which, while an AC driving is carried out so that (i) data signals having opposite polarities are written to respective picture elements adjacent to each other within the same row, (ii) a polarity of a data signal supplied to each data signal line is reversed at least once during one (1) vertical period, and (iii) a polarity of a data signal written to each picture element is reversed for every predetermined period, an effective value of a voltage applied to liquid crystal is less likely to differ between a picture element to which a data signal having a positive polarity is written and a picture element to which a data signal having a negative polarity is written.

### BRIEF DESCRIPTION OF DRAWINGS

FIG. 1 is a view showing an embodiment of the present invention. Each of FIGS. 1(a) and 1(b) is a waveform chart illustrating a first embodiment of how a display device is driven.

FIG. 2 is a view showing another embodiment of the present invention. Each of FIGS. 2(a) and 2(b) is a waveform chart illustrating a second embodiment of how a display device is driven.

FIG. 3 is a view showing a further embodiment of the present invention. Each of FIGS. 3(a) and 3(b) is a waveform chart illustrating a third embodiment of how a display device is driven.

FIG. 4, showing an embodiment of the present invention, is a view illustrating how an AC driving is carried out in a display device.

FIG. 5, showing an embodiment of the present invention, is a timing chart illustrating control signals for a display drive.

FIG. 6, showing an embodiment of the present invention, is a block diagram illustrating how a display device is configured.

FIG. 7 is a view showing a conventional art. FIG. 7(a) is a plan view illustrating how picture elements are configured.

FIG. 7(b) is a cross-sectional view illustrating how the picture elements are configured.

FIG. 8, showing a conventional art, is a view illustrating how an AC driving is carried out in a display device.

FIG. 9 is a view showing a conventional art. Each of FIGS. 9(a) and 9(b) is a waveform chart illustrating how a display device is driven.

### DESCRIPTION OF EMBODIMENTS

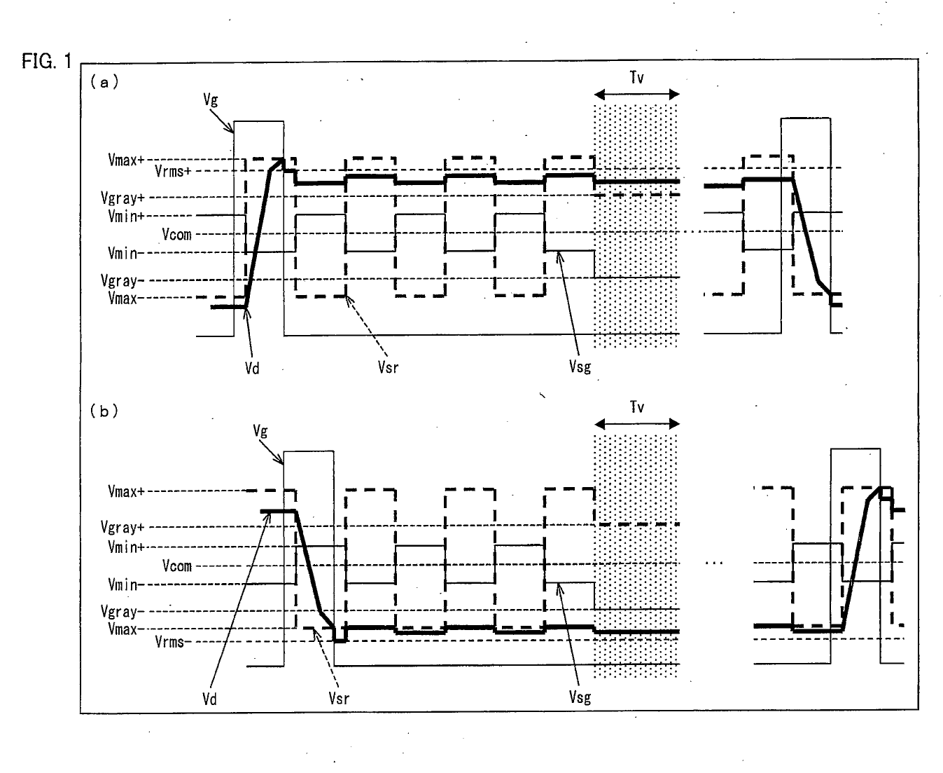

The following description discusses embodiments of the present invention with reference to FIGS. 1 through 6.

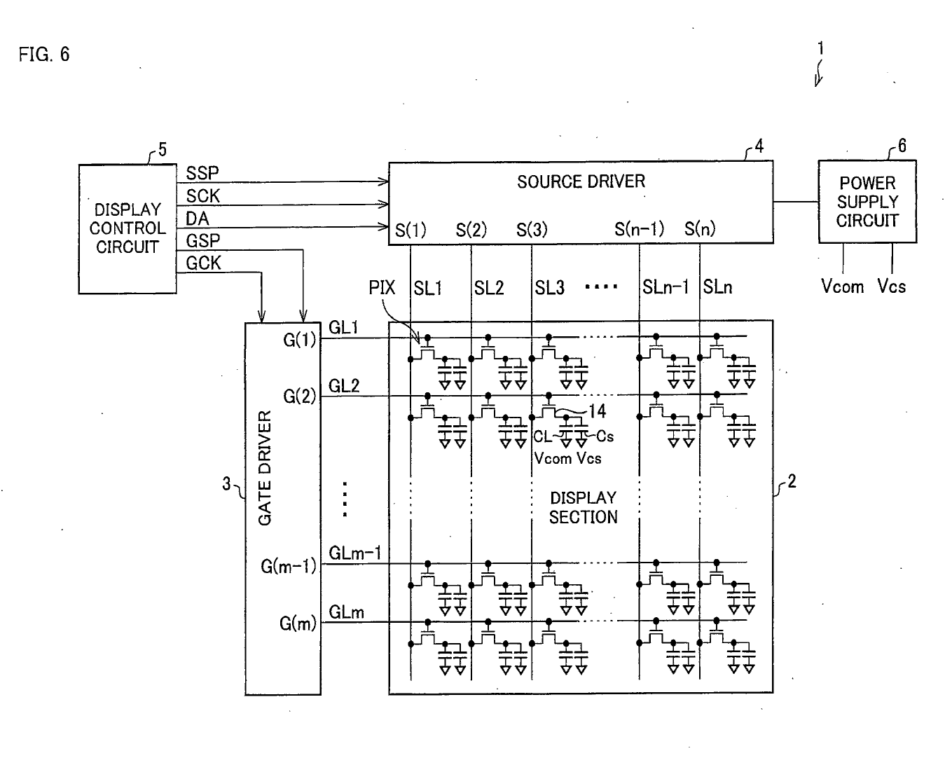

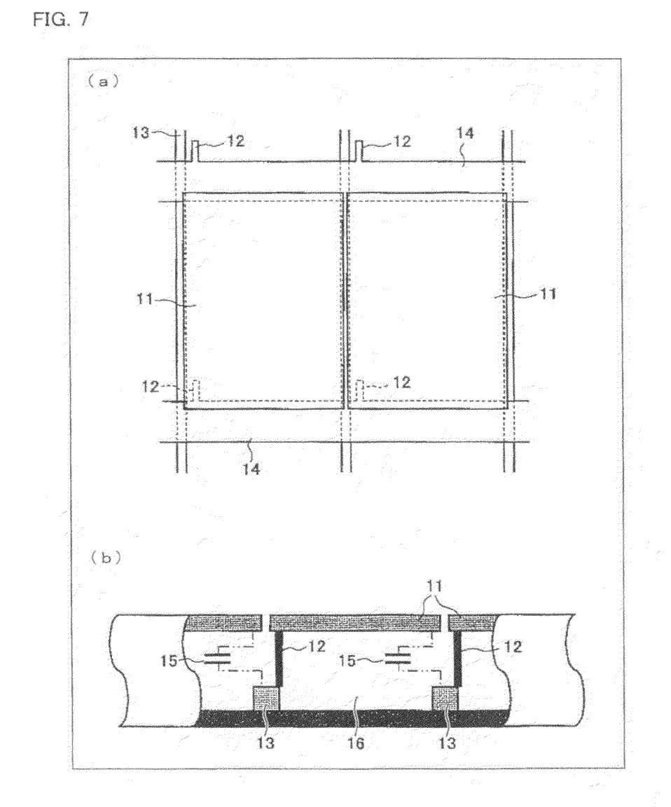

FIG. 6 illustrates how a liquid crystal display device (display device) 1 of the present embodiment is configured.

The liquid crystal display device 1 is an active matrix display device, and includes a gate driver 3 serving as a scanning signal line driver circuit, a source driver 4 serving as a data signal line drive circuit, a display section 2, a display control circuit 5 for controlling the gate driver 3 and the source driver 4, and a power supply circuit 6. The liquid crystal display device 1 employs an AC driving, in which (i) data signals having opposite polarities are written to respective picture elements adjacent to each other within the same row, (ii) a polarity of a data signal supplied to each data signal line is reversed at least once during one (1) vertical period, and (iii) a polarity of a data signal written to each picture element is reversed for every predetermined period (here, every one frame period). A dot inversion driving is encompassed in such an AC driving.

The display section 2 has (i) a plurality (m) of gate lines GL1 through GLm serving as scanning signal lines, (ii) a plurality (n) of source lines SL1 through SLn serving as data signal lines and intersecting the plurality of gate lines GL1 through GLm, and (iii) a plurality (m×n) of picture elements PIX provided so as to correspond to respective intersections of the plurality of gate lines GL1 through GLm and the plurality of source lines SL1 through SLn. The display section 2 further has retention capacitor wires (not illustrated) arranged in parallel with the plurality of gate lines GL1 through GLm. A corresponding one of the retention capacitor wires is allocated to each row, which includes n picture elements arranged in a direction in which the retention capacitor wire extends.

The plurality of picture elements PIX are arranged in a matrix manner so as to form picture element array. Each of the plurality of picture elements PIX includes a TFT 14, a liquid crystal capacitor CL, and a retention capacitor Cs. A gate electrode of the TFT 14 is connected with a gate line GLj (1≦j≦m), a source electrode of the TFT 14 is connected with a source line SLi (1≦j≦n), and a drain electrode of the TFT 14 is connected with a picture element electrode. The liquid crystal capacitor CL, is constituted by (i) the picture element electrode, (ii) a common electrode facing the picture element electrode, and (iii) a liquid crystal layer sandwiched between the picture element electrode and the common electrode. The common electrode receives a common electrode electric potential Vcom from the power supply circuit 6. Each of the retention capacitor wires receives a retention capacitor electric potential Vcs from the power supply circuit 6. The liquid crystal capacitor CL and the retention capacitor Cs form picture element capacitance; however, the picture element capacitance further has other capacitance, i.e., parasitic capacitance between the picture element electrode and a wire around the picture element.

The display control circuit 5 supplies a gate start pulse GSP and a gate clock signal GCK to the gate driver 3, and supplies a source start pulse SSP, a source clock signal SCK, and a display data DA to the source driver 4. The power supply circuit 6 generates and supplies a gray scale reference voltage to the source driver 4. The power supply circuit 6 further generates and outputs the common electrode electric potential Vcom and the retention capacitor electric potential Vcs.

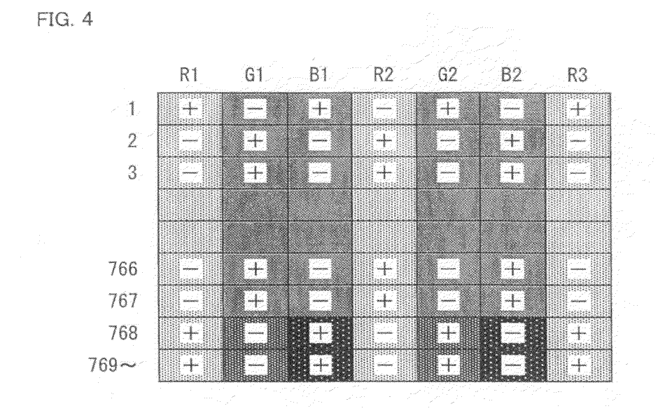

In the present embodiment, assume that, in the liquid crystal display device 1 in which a column (R1, R2, . . . ) of R picture elements, a column (G1, G2, . . . ) of G picture elements, and a column (B1, B2, . . . ) of B picture elements are arranged in this order (see FIG. 4), an AC driving is carried out so that (i) data signals having opposite polarities are written to respective picture elements adjacent to each other within the same row, (ii) a polarity of a data signal supplied to each source line SL is reversed at least once during one (1) vertical period, and (iii) a polarity of a data signal written to each picture element is reversed for every one (1) frame. A dot inversion driving is encompassed in such an AC driving. In the following example, in each column during each frame, a polarity of a data signal written to each picture element is reversed, remains the same for two horizontal periods, and thereafter is reversed again. Note, however, that the example encompasses a case in which a general inversion driving is carried out so that, in each column, a polarity of a data signal written to each picture element is reversed and thereafter remains the same for k (k is a natural number) horizontal periods. In a case where k=1, the inversion driving is equivalent to a dot inversion driving.

For example, assume that the number of rows of picture elements effective for a display is 768 when the AC driving of FIG. 4 is carried out. In this case, during a vertical blanking interval, a data signal stops being supplied to each source line SL so that the each source line SL retains a data signal supplied to a picture element in a 768-th row, i.e., the last row. According to FIG. 4, 769-th row and later correspond to the vertical blanking interval.

The present embodiment deals with a drive method applicable to any image display. In order to clarify an effect of the drive method, assume that an image having a single color such as R, G, or B is displayed in FIG. 4. For example, an image having a single color of R is displayed. Note here that, during the vertical blanking interval, the plurality of source lines SL are caused to retain data signals for R, G, B picture elements so that an achromatic display (gray display, white display, or black display) is caused by a combination of the R, G, and B. The same applies to a case where an image having a single color of G or B is displayed.

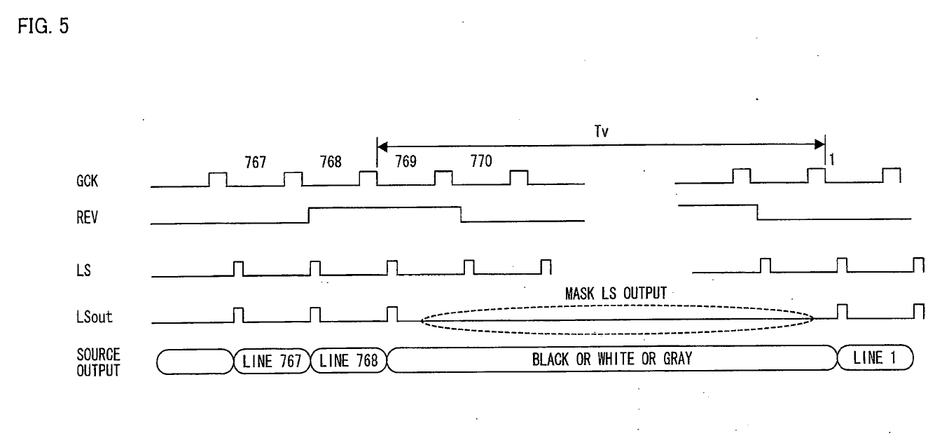

In order to cause the plurality of source lines SL to retain the data signals for the achromatic color display during the vertical blanking interval, an output instruction signal LSout is caused to be effective by use of a latch strobe signal LS supplied during a first horizontal period (in FIG. 5, 769-th horizontal period) in the vertical blanking interval (see FIG. 5). During second and later horizontal periods in the vertical blanking interval Tv, the output instruction signal LSout stops being generated by masking the latch strobe signal LS. The gate clock signal GCK serves as a timing signal which marks a start of each horizontal period, and a polarity of a data signal is determined by a polarity reversal instruction signal REV supplied from the display control circuit 5. The polarity reversal instruction signal REV of FIG. 5 is a pulse signal, which corresponds to FIG. 4 and in which High and Low are reversed for every two horizontal periods. A polarity of a data signal to be supplied during the first horizontal period in the vertical blanking interval Tv can be determined by extrapolating the polarity reversal signal REV supplied during horizontal periods for an effective display region (1 through 768) to the vertical blanking interval TV such that a frequency and duty of the polarity reversal signal REV remain the same.

The following description discusses an embodiment regarding details of the foregoing drive method. The embodiment describes with an example in which (i) an inversion driving is carried out such that, in each frame, data signals having an identical polarity are written for k horizontal period(s) from a time when a polarity is reversed and (ii) k=1.

### Embodiment 1

Each of FIG. 1(a) and FIG. 1(b) illustrates a drive method of the present embodiment.

FIG. 1(a) illustrates a waveform of an electric potential Vd of a picture element electrode to which a data signal having a positive polarity is written, which waveform is obtained during one (1) frame in each column supplied with an R data signal. FIG. 1(b) illustrates a waveform of an electric potential Vd of a picture element electrode to which a data signal having a negative polarity is written, which waveform is obtained during the frame same as in FIG. 1(a) in the column same as in FIG. 1(a). Each of FIG. 1(a) and FIG. 1(b) shows both a waveform of an electric potential of an R data signal Vsr and a waveform of an electric potential of a data signal Vsg which is supplied to an adjacent G source line SL. Each of G data and B data is data for a black display. Note here that, taking into consideration a pull-in phenomenon occurring after each data signal is written to a picture element, a waveform of an electric potential of the each data signal is often set so that its center of positive and negative peaks slightly deviates from a common electrode electric potential Vcom in a positive direction.

As illustrated in FIG. 1(a), the electric potential Vd of the picture element electrode to which the R data signal Vsr having a positive polarity was written during a period of a gate pulse Vg changes, every time the polarity of the R data signal is reversed thereafter, via (i) parasitic capacitance between the picture element electrode of the subject picture element and a source line SL corresponding to the subject picture element and (ii) parasitic capacitance between the picture element electrode of the subject picture element and a G source line SL corresponding to an adjacent picture element.

Assume that (i) an electric potential of a data signal having a positive polarity has a value falling within a range from a minimum value of Vmin+ to a maximum value of Vmax+ and (ii) an electric potential of a data signal having a negative polarity has a value falling within a range from a minimum value of Vmax− to a maximum value of Vmin−. Then, Vmax−<Vmin−<Vcom<Vmin+<Vmax+.

In a case of a normally black display, the electric potential of the R data signal Vsr largely deviates from the common electrode electric potential Vcom, as compared with those of the G data signal Vsg and B data signal Vsb each of which causes a black display. In this case, the electric potential of the data signal Vsr is Vmax+ when it is positive and Vmax− when it is negative. Further, the R data signal Vsr has a polarity reverse to that of the data signal Vsg of the source line SL corresponding to the adjacent picture element. The electric potential of the data signal Vsg is Vmin+ when it is positive and Vmin− when it is negative.

Accordingly, every time the R data signal Vsr is written to another picture element electrode in the same column, the electric potential Vd of the picture element electrode of the subject picture element changes, taken as a whole, as if it is pulled toward a polarity of an electric potential of the data signal Vsr written to the another picture element electrode.

During the vertical blanking interval Tv, source lines SL for R, G, and B are supplied with and caused to retain R, G, and B data signals for gray displays, respectively, each of which signals has a polarity identical to that of a data signal supplied immediately before the vertical blanking interval Tv. The polarity of each of the R, G, and B data signals is caused to be identical to a polarity of a data signal supplied to a picture element in the last row. As illustrated in FIG. 1(a), an electric potential Vgray+ of the R data signal for the gray display satisfies Vmin+<Vgray+<Vmax+, and an electric potential Vgray− of each of the G and B data signals for the gray displays satisfies Vmax−<Vgray−<Vmin−. A difference between an electric potential of a data signal for a gray display and the common electrode electric potential Vcom can differ between R, G, and B, both on a positive side and a negative side. Note here that, for convenience of description, the difference is the same between R, G, and B.

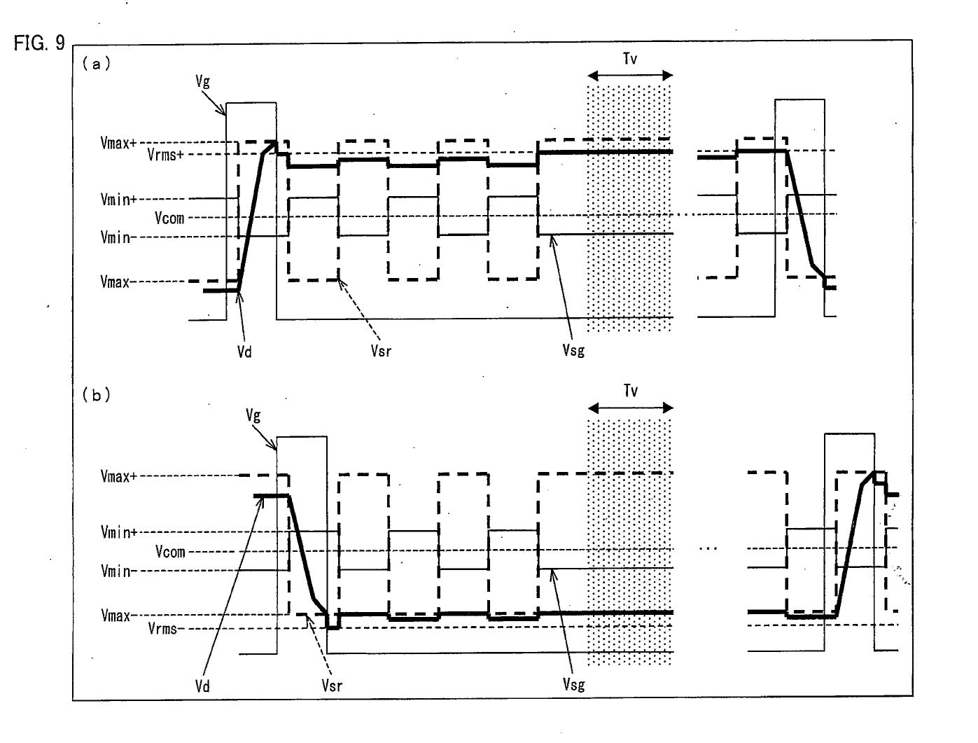

Accordingly, at a start of the vertical blanking interval Tv, the following occurs. That is, in a case where a data signal Vsr supplied to a picture element in the last row of one (1) frame has a positive polarity, an electric potential of a picture element electrode of an R picture element is (i) affected and reduced by, via parasitic capacitance between the picture element electrode of the R picture element and a source line SL corresponding to the R picture element, a change of an electric potential of the source line SL corresponding to the R picture element to the electric potential Vgray+ and (ii) affected and reduced by, via parasitic capacitance between the picture element electrode of the R picture element and a source line SL corresponding to an adjacent picture element, a change of an electric potential of the source line SL corresponding to the adjacent picture element to the electric potential Vgray−. Accordingly, unlike FIG. 9(a), the picture element electrode of the R picture element of FIG. 1(a) undergoes a change in its electric potential so that the electric potential as a whole decreases. As a result, an effective value Vrms+ of a voltage applied to liquid crystal in the R picture element of FIG. 1(a) is smaller than the effective value Vrms+ of FIG. 9(a).

Further, as illustrated in FIG. 1(b), the electric potential Vd of the picture element electrode to which the R data signal Vsr having a negative polarity was written changes in the similar manner via parasitic capacitance, every time the polarity of the R data signal Vsr is reversed thereafter. During the vertical blanking interval Tv, each source line SL is supplied with and caused to retain the data signal described with reference to FIG. 1(a).

Accordingly, at the start of the vertical blanking interval Tv, an electric potential of a picture element electrode of an R picture element electrode is (i) affected and reduced by, via parasitic capacitance between the picture element electrode of the R picture element and a source line SL corresponding the R picture element, a change of an electric potential of the source line SL corresponding to the R picture element to the electric potential Vgray+ and (ii) affected and reduced by, via parasitic capacitance between the picture element electrode of the R picture element and the source line SL corresponding to an adjacent picture element, a change of an electric potential of the source line SL corresponding to the adjacent picture element to the electric potential Vgray−. Accordingly, unlike FIG. 9(b), the picture element electrode of the R picture element of FIG. 1(b) undergoes a change in its electric potential so that the electric potential as a whole decreases. As a result, an effective value Vrms− of a voltage applied to liquid crystal in the R picture element of FIG. 1(b) is larger than the effective value Vrms− of FIG. 9(b).

On the other hand, in a case where the data signal Vsr supplied to the R picture element in the last row of one (1) frame has a negative polarity, a change opposite to the above example occurs. That is, each of (i) the electric potential Vd of the picture element electrode to which the R data signal Vsr having the positive polarity was written and (ii) the electric potential Vd of the picture element electrode to which the R data signal Vsr having the negative polarity was written undergoes a change so that the electric potential Vd as a whole increases.

As described above, according to the present embodiment, as is clear from FIGS. 1(a) and 1(b), in a case where the data signal Vsr written to the R picture element in the last row of one (1) frame has a positive polarity, (i) an effective value of a voltage applied to liquid crystal in an R picture element having a positive polarity is smaller than that of a conventional technique and (ii) an effective value of a voltage applied to liquid crystal in an R picture element having a negative polarity is larger than that of a conventional technique. On the other hand, in a case where the data signal Vsr written to the R picture element in the last row of one (1) frame has a negative polarity, (a) an effective value of a positive voltage applied to liquid crystal in an R picture element is larger than that of a conventional technique and (b) an effective value of a negative voltage applied to liquid crystal in an R picture element is smaller than that of a conventional technique. As a result, an effective value of a voltage applied to liquid crystal in an R picture element having a positive polarity and an effective value of a voltage applied to liquid crystal in an R picture element having a negative polarity are close to each other as compared to a conventional technique or are equal to each other.

The present embodiment is applicable also to a normally white display. In a case of the normally white display, a high-low relationship is reversed between electric potentials for white data and black data, i.e., (i) the electric potential of the data signal Vsr is Vmin+ when it is positive and Vmin− when it is negative and (ii) the electric potential of the data signal Vsg is Vmax+ when it is positive and Vmax− when it is negative. In this case, every time the R data signal Vsr is written to another picture element electrode, the electric potential Vd of the picture element electrode of the subject picture element changes, taken as a whole, as if it is pulled toward a polarity of an electric potential of the data for the black display. At the start of the vertical blanking interval Tv, the following occurs. That is, in a case where the data signal Vsr written to the R picture element in the last row of one (1) frame has a positive polarity, (a) an effective value of a voltage applied to liquid crystal in an R picture element to which a data signal having a negative polarity is written is smaller than that of a conventional technique due to a reduction in an electric potential of a picture element electrode of the R picture element and (b) an effective value of a voltage applied to liquid crystal in an R picture element to which a data signal having a positive polarity is written is larger than that of a conventional technique due to a reduction in an electric potential of a picture element electrode of the R picture element. On the other hand, in a case where the data signal Vsr written to the R picture element in the last row of one (1) frame has a negative polarity, (I) an effective value of a positive voltage applied to liquid crystal in an R picture element is smaller than that of a conventional technique and (II) an effective value of a negative voltage applied to liquid crystal in an R picture element is larger than that of a conventional technique. As a result, an effective value of a voltage applied to liquid crystal in an R picture element having a positive polarity and an effective value of a voltage applied to liquid crystal in an R picture element having a negative polarity are close to each other as compared to a conventional technique or are equal to each other.

Needless to say, the present embodiment is applicable also to a case where an image having a single color of G, B or the like is displayed.

According to the foregoing configuration, it is possible to achieve a display device and a method for driving a display device in each of which, while an AC driving is carried out so that (i) data signals having opposite polarities are written to respective picture elements adjacent to each other within the same row, (ii) a polarity of a data signal supplied to each data signal line is reversed at least once during one (1) vertical period, and (iii) a polarity of a data signal written to each picture element is reversed for every one (1) frame period (predetermined period), an effective value of a voltage applied to liquid crystal is less likely to differ between a picture element to which a data signal having a positive polarity is written and a picture element to which a data signal having a negative polarity is written.

The foregoing description discussed a configuration in which, during a vertical blanking interval, a data signal having a polarity identical to that of a data signal supplied immediately before the vertical blanking interval is supplied to each data signal line; however, the present embodiment is not limited to this. Alternatively, it is possible to employ a configuration in which, during the vertical blanking interval, a data signal for a gray display which signal has a polarity reverse to that of the data signal supplied immediately before the vertical blanking interval is supplied to and retained in each data signal line.

According to such a configuration, in a case where an image having a single color is displayed, the following occurs at the start of the vertical blanking interval. That is, in a case of a normally black display, in a case where a data signal supplied to a picture element in the last row of one (1) frame has a positive polarity, an electric potential of a picture element electrode of a picture element (subject picture element) to which a data signal for the single color is written is (i) affected and largely reduced by, via parasitic capacitance between the picture element electrode of the subject picture element and a data signal line corresponding to the subject picture element, a change of an electric potential of the data signal line corresponding to the subject picture element to an electric potential for a gray display having an opposite polarity and (ii) affected and slightly increased by, via parasitic capacitance between the picture element electrode of the subject picture element and a data signal line corresponding to an adjacent picture element, a change of an electric potential of the data signal line corresponding to the adjacent picture element to an electric potential for a gray display having an opposite polarity. Accordingly, the picture element electrode of the subject picture element undergoes a change in its electric potential so that the electric potential as a whole decreases. In a case where the data signal supplied to the picture element in the last row of one (1) frame has a negative polarity, the picture element electrode of the subject picture element undergoes a change in its electric potential so that the electric potential as a whole increases.

Accordingly, in a case where a data signal written to a picture element in the last row of one (1) frame has a positive polarity, (i) an effective value of a positive voltage applied to liquid crystal in the subject picture element is smaller than that of a conventional technique and (ii) an effective value of a negative voltage applied to liquid crystal in the subject picture element is larger than that of a conventional technique. In a case where the data signal written to the picture element in the last raw of one (1) frame has a negative polarity, (a) the effective value of the positive voltage applied to liquid crystal in the subject picture element is larger than that of a conventional technique and (b) the effective value of the negative voltage applied to liquid crystal in the subject picture element is smaller than that of a conventional technique. As a result, an effective value of a positive voltage applied to liquid crystal and an effective value of a negative voltage applied to liquid crystal are close to each other as compared to a conventional technique or are equal to each other.

On the other hand, in a case of a normally white display, the following occurs. That is, in a case where a data signal written to a picture element in the last row of one (1) frame has a positive polarity, (i) an effective value of a voltage applied to liquid crystal in a subject picture element to which a positive data signal for the single color is written is larger than that of a conventional technique and (ii) an effective value of a voltage applied to liquid crystal in a subject picture element to which a negative data signal for the single color is written is smaller than that of a conventional technique. In a case where the data signal written to the picture element in the last row of one (1) frame has a negative polarity, (a) an effective value of a positive voltage applied to liquid crystal in the subject picture element is smaller than that of a conventional technique and (b) an effective value of a negative voltage applied to liquid crystal in the subject picture element is larger than that of a conventional technique. As a result, an effective value of a positive voltage applied to liquid crystal and an effective value of a negative voltage applied to liquid crystal are close to each other as compared to a conventional technique or are equal to each other.

According to the foregoing configuration, it is possible to achieve a display device in which, while an AC driving is carried out so, that (i) data signals having opposite polarities are written to respective picture elements adjacent to each other within the same row, (ii) a polarity of a data signal supplied to each data signal line is reversed at least once during one (1) vertical period, and (iii) a polarity of a data signal written to each picture element is reversed for every predetermined period, an effective value of a voltage applied to liquid crystal is less likely to differ between a picture element to which a data signal having a positive polarity is written and a picture element to which a data signal having a negative polarity is written.

### Embodiment 2

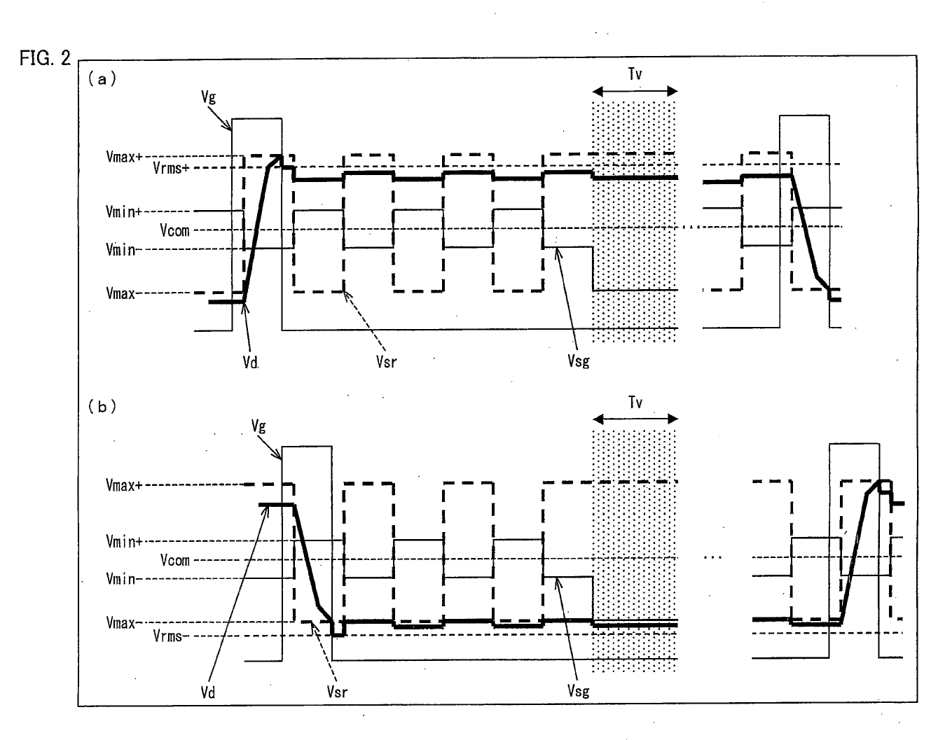

Each of FIGS. 2(a) and 2(b) illustrates a drive method of the present embodiment.

FIG. 2(a) illustrates a waveform of an electric potential Vd of a picture element electrode to which a data signal having a positive polarity is written, which waveform is obtained during one (1) frame in each column supplied with an R data signal. FIG. 2(b) illustrates a waveform of an electric potential Vd of a picture element electrode to which a data signal having a negative polarity is written, which waveform is obtained during the frame same as in FIG. 2(a) in the column same as in FIG. 2(a). Each of FIGS. 2(a) and 2(b) illustrates both (i) a waveform of an electric potential of an R data signal Vsr and (ii) a waveform of an electric potential of a data signal Vsg which is supplied to an adjacent G source line SL. Each of G data and B data is data for a black display. Note that, taking into consideration a pull-in phenomenon occurring after each data signal is written to a picture element, a waveform of an electric potential of the each data signal is often set so that its center of positive and negative peaks slightly deviates from a common electrode electric potential Vcom in a positive direction.

As illustrated in FIG. 2(a), the electric potential Vd of the picture element electrode to which the R data signal Vsr having a positive polarity was written during a period of a gate pulse Vg changes, every time a polarity of the R data signal Vsr is reversed thereafter, via (i) parasitic capacitance between the picture element electrode of the subject picture element and a source line SL corresponding to the subject picture element and (ii) parasitic capacitance between the picture element electrode of the subject picture element and a G source line SL corresponding to an adjacent picture element.

Assume that (i) an electric potential of a data signal having a positive polarity has a value falling within a range from a minimum value of Vmin+ to a maximum value of Vmax+ and (ii) an electric potential of a data signal having a negative polarity has a value falling within a range from a minimum value of Vmax− to a maximum value of Vmin−. Then, Vmax−<Vmin−<Vcom<Vmin+<Vmax+.

In a case of a normally black display, the electric potential of the R data signal Vsr largely deviates from the common electrode electric potential Vcom, as compared with those of the G data signal Vsg and B data signal Vsb each of which causes a black display. In this case, the electric potential of the data signal Vsr is Vmax+ when it is positive and Vmax− when it is negative. Further, the R data signal Vsr has a polarity reverse to that of the data signal Vsg of the source line SL corresponding to the adjacent picture element. The electric potential of the data signal Vsg is Vmin+ when it is positive and Vmin− when it is negative.

Accordingly, every time the R data signal Vsr is written to another picture element electrode in the same column, the electric potential Vd of the picture element electrode of the subject picture element changes, taken as a whole, as if it is pulled toward a polarity of an electric potential of the data signal Vsr written to the another picture element electrode.

During a vertical blanking interval Tv, source lines SL for R, G and B are supplied with and caused to retain R, G, and B data signals for white displays, respectively, each of which data signals has a polarity identical to that of a data signal supplied immediately before the vertical blanking interval Tv. The polarity of each of the R, G, and B data signals is caused to be identical to a polarity of a data signal supplied to a picture element in the last row. As illustrated in FIG. 2(a), an electric potential of the R data signal for the white display is Vmax+, whereas an electric potential of each of the G data and B data for the white displays is Vmax−. A difference between an electric potential of a data signal for the white display and the common electrode electric potential Vcom can differ between R, G, and B, both on a positive side and a negative side. Note here that, for convenience of description, the difference is the same between R, G, and B.

Accordingly, at a start of the vertical blanking interval Tv, the following occurs. That is, an electric potential of a picture element electrode of an R picture element (i) receives no affection via parasitic capacitance between the picture element electrode of the R picture element and a source line SL corresponding to the R picture element because there is no change in an electric potential of the source line SL corresponding to the R picture element, and (ii) is affected and reduced by, via parasitic capacitance between the picture element electrode of the R picture element and a source line SL corresponding to an adjacent picture element, a change of an electric potential of the source line SL corresponding to the adjacent picture element to the electric potential Vmax−. Accordingly, unlike FIG. 9(a), the picture element electrode of the R picture element of FIG. 2(a) undergoes a change in its electric potential so that the electric potential as a whole decreases. As a result, an effective value Vrms+ (see FIG. 2(a)) of a voltage applied to liquid crystal in the R picture element is smaller than the effective value Vrms+ of FIG. 9(a).

Further, as illustrated in FIG. 2(b), the electric potential Vd of the picture element electrode to which the R data signal Vsr having a negative polarity was written changes in the similar manner via parasitic capacitance, every time the polarity of the R data signal Vsr is reversed thereafter. During the vertical blanking interval Tv, each source line SL is supplied with and caused to retain the data signal described with reference to FIG. 2(a).

Accordingly, at the start of the vertical blanking interval Tv, the following occurs. That is, in a case where a data signal Vsr supplied to a picture element in the last row of one (1) frame has a positive polarity, an electric potential of a picture element electrode of an R picture element is (i) affected and reduced by, via parasitic capacitance between the picture element electrode of the R picture element and a source line SL corresponding to the R picture element, an electric potential of the source line SL corresponding to the R picture element which electric potential remains the same, and (ii) is affected and reduced by, via parasitic capacitance between the picture element electrode of the R picture element and a source line SL corresponding to an adjacent picture element, a change of an electric potential of the source line SL corresponding to the adjacent picture element to the electric potential Vmax−. Accordingly, unlike FIG. 9(b), the picture element electrode of the R picture element of FIG. 2(b) undergoes a change in its electric potential so that the electric potential as a whole decreases. As a result, an effective value Vrms− (see FIG. 2(b)) of a voltage applied to liquid crystal in the R picture element is larger than the effective value Vrms− of FIG. 9(b).

On the other hand, in a case where the data signal Vsr supplied to the R picture element in the last row of one (1) frame has a negative polarity, a change opposite to the above example occurs. That is, each of (i) the electric potential Vd of the picture element electrode to which the R data signal Vsr having the positive polarity is written and (ii) the electric potential Vd of the picture element electrode to which the R data signal Vsr having the negative polarity is written undergoes a change so that the electric potential Vd as a whole increases.

As described above, according to the present embodiment, as is clear from FIGS. 2(a) and 2(b), in a case where the data signal Vsr written to the R picture element in the last row of one (1) frame has a positive polarity, (i) an effective value of a voltage applied to liquid crystal in an R picture element having a positive polarity is smaller than that of a conventional technique and (ii) an effective value of a voltage applied to liquid crystal in an R picture element having a negative polarity is larger than that of a conventional technique. On the other hand, in a case where the data signal Vsr written to the R picture element in the last row of one (1) frame has a negative polarity, (a) an effective value of a positive voltage applied to liquid crystal in an R picture element is larger than that of a conventional technique and (b) an effective value of a negative voltage applied to liquid crystal in an R picture element is smaller than that of a conventional technique. As a result, an effective value of a voltage applied to liquid crystal in an R picture element having a positive polarity and an effective value of a voltage applied to liquid crystal in an R picture element having a negative polarity are close to each other as compared to a conventional technique or are equal to each other.

The present embodiment is applicable also to a normally white display. In a case of the normally white display, a high-low relationship is reversed between electric potentials for white data and black data, i.e., (i) the electric potential of the data signal Vsr is Vmin+ when it is positive and Vmin− when it is negative and (ii) the electric potential of the data signal Vsg is Vmax+ when it is positive and Vmax− when it is negative. In this case, every time the R data signal Vsr is written to another picture element electrode, the electric potential Vd of the picture element electrode of the subject picture element changes, taken as a whole, as if it is pulled toward a polarity of an electric potential of the data for the black display. At the start of the vertical blanking interval Tv, the following occurs. That is, in a case where the data signal Vsr written to the R picture element in the last row of one (1) frame has a positive polarity, (a) an effective value of a voltage applied to liquid crystal in an R picture element to which a data signal having a negative polarity is written is smaller than that of a conventional technique due to a reduction in an electric potential of a picture element electrode of the R picture element and (b) an effective value of a voltage applied to liquid crystal in an R picture element to which a data signal having a positive polarity is written is larger than that of a conventional technique due to a reduction in an electric potential of a picture element electrode of the R picture element. On the other hand, in a case where the data signal Vsr written to the R picture element in the last row of one (1) frame has a negative polarity, (I) an effective value of a positive voltage applied to liquid crystal in an R picture element is smaller than that of a conventional technique and (II) an effective value of a negative voltage applied to liquid crystal in an R picture element is larger than that of a conventional technique. As a result, an effective value of a voltage applied to liquid crystal in an R picture element having a positive polarity and an effective value of a voltage applied to liquid crystal in an R picture element having a negative polarity are close to each other as compared to a conventional technique or are equal to each other.

Needless to say, the present embodiment is applicable also to a case where an image having a single color of G, B or the like is displayed.

According to the foregoing configuration, it is possible to achieve a display device and a method for driving a display device in each of which, while an AC driving is carried out so that (i) data signals having opposite polarities are written to respective picture elements adjacent to each other within the same row, (ii) a polarity of a data signal supplied to each data signal line is reversed at least once during one (1) vertical period, and (iii) a polarity of a data signal written to each picture element is reversed for every one (1) frame period (predetermined period), an effective value of a voltage applied to liquid crystal is less likely to differ between a picture element to which a data signal having a positive polarity is written and a picture element to which a data signal having a negative polarity is written.

The foregoing description discussed a configuration in which, during a vertical blanking interval, a data signal having a polarity identical to that of a data signal supplied immediately before the vertical blanking interval is supplied to each data signal line; however, the present embodiment is not limited to this. Alternatively, it is possible to employ a configuration in which, during the vertical blanking interval, a data signal for a white display which signal has a polarity reverse to that of the data signal supplied immediately before the vertical blanking interval is supplied to and retained in each data signal line.

According to such a configuration, in a case where an image having a single color is displayed, the following occurs at the start of the vertical blanking interval. That is, in a case of a normally black display, in a case where a data signal supplied to a picture element in the last row of one (1) frame has a positive polarity, an electric potential of a picture element electrode of a picture element (subject picture element) to which a data signal for the single color is written is (i) affected and largely reduced by, via parasitic capacitance between the picture element electrode of the subject picture element and a data signal line corresponding to the subject picture element, a change of an electric potential of the data signal line corresponding to the subject picture element to an electric potential for a white display having an opposite polarity and (ii) affected and slightly increased by, via parasitic capacitance between the picture element electrode of the subject picture element and a data signal line corresponding to an adjacent picture element, a change of an electric potential of the data signal line corresponding to the adjacent picture element to an electric potential for a white display having an opposite polarity. Accordingly, the picture element electrode of the subject picture element undergoes a change in its electric potential so that the electric potential as a whole decreases. In a case where the data signal supplied to the picture element in the last row of one (1) frame has a negative polarity, the picture element electrode of the subject picture undergoes a change in its electric potential so that the electric potential as a whole increases.

Accordingly, in a case where a data signal written to a picture element in the last row of one (1) frame has a positive polarity, (i) an effective value of a positive voltage applied to liquid crystal in the subject picture element is smaller than that of a conventional technique and (ii) an effective value of a negative voltage applied to liquid crystal in the subject picture element is larger than that of a conventional technique. In a case where the data signal written to the picture element in the last raw of one (1) frame has a negative polarity, (a) the effective value of the positive voltage applied to liquid crystal in the subject picture element is larger than that of a conventional technique and (b) the effective value of the negative voltage applied to liquid crystal in the subject picture element is smaller than that of a conventional technique. As a result, an effective value of a positive voltage applied to liquid crystal and an effective value of a negative voltage applied to liquid crystal are close to each other as compared to a conventional technique or are equal to each other.

On the other hand, in a case of a normally white display, the following occurs. That is, in a case where a data signal written to a picture element in the last row of one (1) frame has a positive polarity, (i) an effective value of a voltage applied to liquid crystal in a subject picture element to which a positive data signal for the single color is written is larger than that of a conventional technique and (ii) an effective value of a voltage applied to liquid crystal in a subject picture element to which a negative data signal for the single color is written is smaller than that of a conventional technique. In a case where the data signal written to the picture element in the last row of one (1) frame has a negative polarity, (a) an effective value of a positive voltage applied to liquid crystal in the subject picture element is smaller than that of a conventional technique and (b) an effective value of a negative voltage applied to liquid crystal in the subject picture element is larger than that of a conventional technique. As a result, an effective value of a positive voltage applied to liquid crystal and an effective value of a negative voltage applied to liquid crystal are close to each other as compared to a conventional technique or are equal to each other.

According to the foregoing configuration, it is possible to achieve a display device in which, while an AC driving is carried out so that (i) data signals having opposite polarities are written to respective picture elements adjacent to each other within the same row, (ii) a polarity of a data signal supplied to each data signal line is reversed at least once during one (1) vertical period, and (iii) a polarity of a data signal written to each picture element is reversed for every predetermined period, an effective value of a voltage applied to liquid crystal is less likely to differ between a picture element to which a data signal having a positive polarity is written and a picture element to which a data signal having a negative polarity is written.

### Embodiment 3

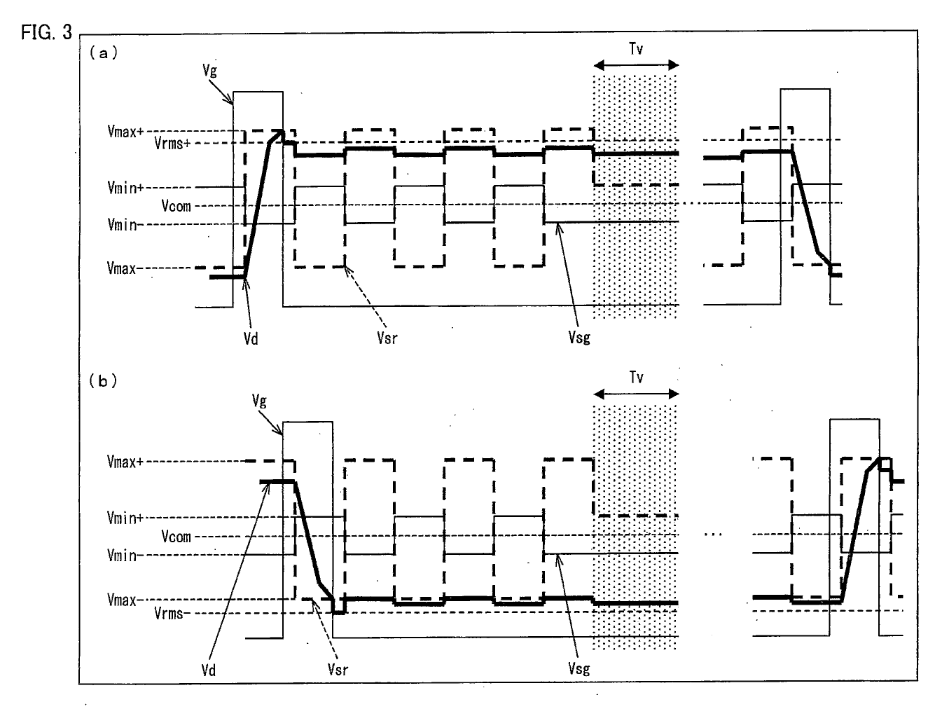

Each of FIGS. 3(a) and 3(b) illustrates a drive method of the present embodiment.

FIG. 3(a) illustrates a waveform of an electric potential Vd of a picture element electrode to which a data signal having a positive polarity is written, which waveform is obtained during one (1) frame in each column supplied with an R data signal. FIG. 3(b) illustrates a waveform of an electric potential Vd of a picture element electrode to which a data signal having a negative polarity is written, which waveform is obtained during the frame same as in FIG. 3(a) in the column same as in FIG. 3(a). Each of FIGS. 3(a) and 3(b) illustrates both (i) a waveform of an electric potential of an R data signal Vsr and (ii) a waveform of an electric potential of a data signal Vsg which is supplied to an adjacent G source line SL. Each of G data and B data is data for a black display. Note that, taking into consideration a pull-in phenomenon occurring after each data signal is written to a picture element, a waveform of an electric potential of the each data signal is often set so that its center of positive and negative peaks slightly deviates from a common electrode electric potential Vcom in a positive direction.

As illustrated in FIG. 3(a), the electric potential Vd of the picture element electrode to which the R data signal Vsr having a positive polarity was written during a period of a gate pulse Vg changes, every time a polarity of the R data signal Vsr is reversed thereafter, via (i) parasitic capacitance between the picture element electrode of the subject picture element and a source line SL corresponding to the subject picture element and (ii) parasitic capacitance between the picture element electrode of the subject picture element and a G source line SL corresponding to an adjacent picture element.

Assume that (i) an electric potential of a data signal having a positive polarity has a value falling within a range from a minimum value of Vmin+ to a maximum value of Vmax+ and (ii) an electric potential of a data signal having a negative polarity has a value falling within a range from a minimum value of Vmax− to a maximum value of Vmin−. Then, Vmax−<Vmin−<Vcom<Vmin+<Vmax+.

In a case of a normally black display, the electric potential of the R data signal Vsr largely deviates from the common electrode electric potential Vcom, as compared with those of the G data signal Vsg and B data signal Vsb each of which causes a black display. In this case, the electric potential of the data signal Vsr is Vmax+ when it is positive and Vmax− when it is negative. Further, the R data signal Vsr has a polarity reverse to that of the data signal Vsg of the source line SL corresponding to the adjacent picture element. The electric potential of the data signal Vsg is Vmin+ when it is positive and Vmin− when it is negative.

Accordingly, every time the R data signal Vsr is written to another picture element electrode in the same column, the electric potential Vd of the picture element electrode of the subject picture element changes, taken as a whole, as if it is pulled toward a polarity of an electric potential of the data signal Vsr written to the another picture element electrode.

During a vertical blanking interval Tv, source lines SL for R, G and B are supplied with and caused to retain R, G, and B data signals for black displays, respectively, each of which data signals has a polarity identical to a data signal supplied immediately before the vertical blanking interval Tv. The polarity of each of the R, G, and B data signals is caused to be identical to that of a polarity of a data signal supplied to a picture element in the last row. As illustrated in FIG. 3(a), an electric potential of the R data signal for the black display is Vmin+, whereas an electric potential of each of the G data and B data for the black displays is Vmin−. A difference between an electric potential of a data signal for the black display and the common electrode electric potential Vcom can differ between R, G, and B, both on a positive side and a negative side. Note here that, for convenience of description, the difference is the same between R, G, and B.

Accordingly, at a start of the vertical blanking interval Tv, the following occurs. That is, in a case where the data signal Vsr supplied to a picture element in the last row of one (1) frame has a positive polarity, an electric potential of a picture element electrode of an R picture element (i) is affected and reduced by, via parasitic capacitance between the picture element electrode of the R picture element and a source line SL corresponding to the R picture element, a change of an electric potential of the source line SL corresponding to the R picture element to the electric potential Vmin+, and (ii) receives no affection via parasitic capacitance between the picture element electrode of the R picture element and a source line SL corresponding to an adjacent picture element because there is no change in an electric potential of the source line SL corresponding to the adjacent picture element. Accordingly, unlike FIG. 9(a), the picture element electrode of the R picture element of FIG. 3(a) undergoes a change in its electric potential so that the electric potential as a whole decreases. As a result, an effective value Vrms+ (see FIG. 3(a)) of a voltage applied to liquid crystal in the R picture element is smaller than the effective value Vrms+ of FIG. 9(a).

Further, as illustrated in FIG. 3(b), the electric potential Vd of the picture element electrode to which the R data signal Vsr having a negative polarity is written changes in the similar manner via parasitic capacitance, every time the polarity of the R data signal Vsr is reversed thereafter. During the vertical blanking interval Tv, each source line SL is supplied with and caused to retain the data signal described with reference to FIG. 3(a).

Accordingly, at the start of the vertical blanking interval Tv, an electric potential of a picture element electrode of an R picture element is (i) affected and reduced by, via parasitic capacitance between the picture element electrode of the R picture element and a source line SL corresponding to the R picture element, a change of an electric potential of the source line SL corresponding to the R picture element to the electric potential Vmin+, and (ii) receives no affection via parasitic capacitance between the picture element electrode of the R picture element and a source line SL corresponding to an adjacent picture element because there is no change in an electric potential of the source line SL corresponding to the adjacent picture element. Accordingly, unlike FIG. 9(b), the picture element electrode of the R picture element of FIG. 3(b) undergoes a change in its electric potential so that the electric potential as a whole decreases. As a result, an effective value Vrms− (see FIG. 3(b)) of a voltage applied to liquid crystal in the R picture element is larger than the effective value Vrms− of FIG. 9(b).

On the other hand, in a case where the data signal Vsr supplied to the R picture element in the last row of one (1) frame has a negative polarity, a change opposite to the above example occurs. That is, each of (i) the electric potential Vd of the picture element electrode to which the R data signal Vsr having the positive polarity is written and (ii) the electric potential Vd of the picture element electrode to which the R data signal Vsr having the negative polarity is written undergoes a change so that the electric potential Vd as a whole increases.

As described above, according to the present embodiment, as is clear from FIGS. 3(a) and 3(b), in a case where the data signal Vsr written to the R picture element in the last row of one (1) frame has a positive polarity, (i) an effective value of a voltage applied to liquid crystal in an R picture element having a positive polarity is smaller than that of a conventional technique and (ii) an effective value of a voltage applied to liquid crystal in an R picture element having a negative polarity is larger than that of a conventional technique. On the other hand, in a case where the data signal Vsr written to the R picture element in the last row of one (1) frame has a negative polarity, (a) an effective value of a positive voltage applied to liquid crystal in an R picture element is larger than that of a conventional technique and (b) an effective value of a negative voltage applied to liquid crystal in an R picture element is smaller than that of a conventional technique. As a result, an effective value of a voltage applied to liquid crystal in an R picture element having a positive polarity and an effective value of a voltage applied to liquid crystal in an R picture element having a negative polarity are close to each other as compared to a conventional technique or are equal to each other.

The present embodiment is applicable also to a normally white display. In a case of the normally white display, a high-low relationship is reversed between electric potentials for white data and black data, i.e., (i) the electric potential of the data signal Vsr is Vmin+ when it is positive and Vmin− when it is negative and (ii) the electric potential of the data signal Vsg is Vmax+ when it is positive and Vmax− when it is negative. In this case, every time the R data signal Vsr is written to another picture element electrode, the electric potential Vd of the picture element electrode of the subject picture element changes, taken as a whole, as if it is pulled toward a polarity of an electric potential of the data for the black display. At the start of the vertical blanking interval Tv, the following occurs. That is, in a case where the data signal Vsr written to the R picture element in the last row of one (1) frame has a positive polarity, (a) an effective value of a voltage applied to liquid crystal in an R picture element to which a data signal having a negative polarity is written is smaller than that of a conventional technique due to a reduction in an electric potential of a picture element electrode of the R picture element and (b) an effective value of a voltage applied to liquid crystal in an R picture element to which a data signal having a positive polarity is written is larger than that of a conventional technique due to a reduction in an electric potential of a picture element electrode of the R picture element. On the other hand, in a case where the data signal Vsr written to the R picture element in the last row of one (1) frame has a negative polarity, (I) an effective value of a positive voltage applied to liquid crystal in an R picture element is smaller than that of a conventional technique and (II) an effective value of a negative voltage applied to liquid crystal in an R picture element is larger than that of a conventional technique. As a result, an effective value of a voltage applied to liquid crystal in an R picture element having a positive polarity and an effective value of a voltage applied to liquid crystal in an R picture element having a negative polarity are close to each other as compared to a conventional technique or are equal to each other.

Needless to say, the present embodiment is applicable also to a case where an image having a single color of G, B or the like is displayed.

According to the foregoing configuration, it is possible to achieve a display device and a method for driving a display device in each of which, while an AC driving is carried out so that (i) data signals having opposite polarities are written to respective picture elements adjacent to each other within the same row, (ii) a polarity of a data signal supplied to each data signal line is reversed at least once during one (1) vertical period, and (iii) a polarity of a data signal written to each picture element is reversed for every one (1) frame period (predetermined period), an effective value of a voltage applied to liquid crystal is less likely to differ between a picture element to which a data signal having a positive polarity is written and a picture element to which a data signal having a negative polarity is written.

The foregoing description discussed a configuration in which, during a vertical blanking interval, a data signal having a polarity identical to that of a data signal supplied immediately before the vertical blanking interval is supplied to each data signal line; however, the present embodiment is not limited to this. Alternatively, it is possible to employ a configuration in which, during the vertical blanking interval, a data signal for a black display which signal has a polarity reverse to that of the data signal supplied immediately before the vertical blanking interval is supplied to and retained in each data signal line.

According to such a configuration, in a case where an image having a single color is displayed, the following occurs at the start of the vertical blanking interval. That is, in a case of a normally black display, in a case where a data signal supplied to a picture element in the last row of one (1) frame has a positive polarity, an electric potential of a picture element electrode of a picture element (subject picture element) to which a data signal for the single color is written is (i) affected and largely reduced by, via parasitic capacitance between the picture element electrode of the subject picture element and a data signal line corresponding to the subject picture element, a change of an electric potential of the data signal line corresponding to the subject picture element to an electric potential for a black display having an opposite polarity and (ii) affected and slightly increased by, via parasitic capacitance between the picture element electrode of the subject picture element and a data signal line corresponding to an adjacent picture element, a change of an electric potential of the data signal line corresponding to the adjacent picture element to an electric potential for a black display having an opposite polarity. Accordingly, the picture element electrode of the subject picture element undergoes a change in its electric potential so that the electric potential as a whole decreases. In a case where the data signal supplied to the picture element in the last row of one (1) frame has a negative polarity, the picture element electrode of the subject picture element undergoes a change in its electric potential so that the electric potential as a whole increases.

Accordingly, in a case where a data signal written to a picture element in the last row of one (1) frame has a positive polarity, (i) an effective value of a positive voltage applied to liquid crystal in the subject picture element is smaller than that of a conventional technique and (ii) an effective value of a negative voltage applied to liquid crystal in the subject picture element is larger than that of a conventional technique. In a case where the data signal written to the picture element in the last raw of one (1) frame has a negative polarity, (a) the effective value of the positive voltage applied to liquid crystal in the subject picture element is larger than that of a conventional technique and (b) the effective value of the negative voltage applied to liquid crystal in the subject picture element is smaller than that of a conventional technique. As a result, an effective value of a positive voltage applied to liquid crystal and an effective value of a negative voltage applied to liquid crystal are close to each other as compared to a conventional technique or are equal to each other.

On the other hand, in a case of a normally white display, the following occurs. That is, in a case where a data signal written to a picture element in the last row of one (1) frame has a positive polarity, (i) an effective value of a voltage applied to liquid crystal in a subject picture element to which a positive data signal for the single color is written is larger than that of a conventional technique and (ii) an effective value of a voltage applied to liquid crystal in a subject picture element to which a negative data signal for the single color is written is smaller than that of a conventional technique. In a case where the data signal written to the picture element in the last row of one (1) frame has a negative polarity, (a) an effective value of a positive voltage applied to liquid crystal in the subject picture element is smaller than that of a conventional technique and (b) an effective value of a negative voltage applied to liquid crystal in the subject picture element is larger than that of a conventional technique. As a result, an effective value of a positive voltage applied to liquid crystal and an effective value of a negative voltage applied to liquid crystal are close to each other as compared to a conventional technique or are equal to each other.

According to the foregoing configuration, it is possible to achieve a display device in which, while an AC driving is carried out so that (i) data signals having opposite polarities are written to respective picture elements adjacent to each other within the same row, (ii) a polarity of a data signal supplied to each data signal line is reversed at least once during one (1) vertical period, and (iii) a polarity of a data signal written to each picture element is reversed for every predetermined period, an effective value of a voltage applied to liquid crystal is less likely to differ between a picture element to which a data signal having a positive polarity is written and a picture element to which a data signal having a negative polarity is written.

The foregoing descriptions discussed the embodiments.

Note that, although the embodiments describe with an example in which an image having a single color is displayed, the embodiments are not limited to this. Also in a case of a general image display, data signals can be supplied like the above embodiments to data signal lines during a vertical blanking interval.

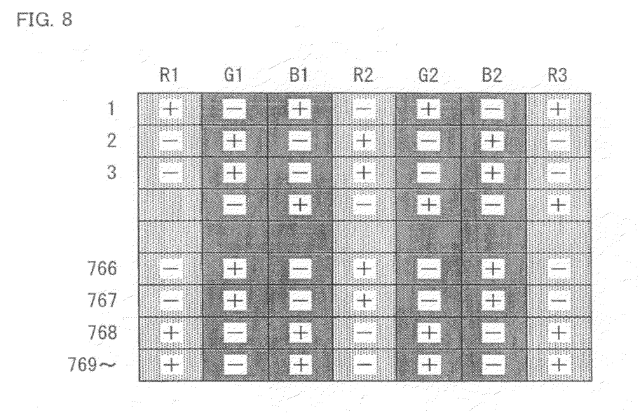

Further, a configuration of a picture element can be any configuration as long as there is parasitic capacitance (i) between a picture element electrode of a subject picture element and a source line corresponding to the subject picture element and (ii) between the picture element electrode of the subject picture element and a source line corresponding to an adjacent picture element. Therefore, a generally known configuration of a picture element can be employed in the present invention. Note however that, in a case of a configuration of a picture element shown in FIG. 8, i.e., the configuration in which a data signal line faces both of (a) a picture element electrode of a subject picture element and (b) a picture element electrode of an adjacent picture element, the present invention provides an extremely large effect because the picture element electrode and the data signal line are highly capacitively-coupled.

The invention is not limited to the description of the embodiments above. Different embodiments may be combined, and the invention may be altered within the scope of the claims. That is, an embodiment based on a proper combination of technical means altered within the scope of the claims is encompassed in the technical scope of the invention.

In order to attain the above object, a display device in accordance with the present invention is an active matrix display device, including: picture elements; and data signal lines, the active matrix display device employing an AC driving in which (i) data signals having opposite polarities are written to respective adjacent ones, of the picture elements, which are adjacent to each other within a same row, (ii) a polarity of a data signal supplied to each of the data signal lines is reversed at least once during one (1) vertical period, and (iii) a polarity of a data signal written to each of the picture elements is reversed for every predetermined period,

during a vertical blanking interval, each of the data signal lines being supplied with a data signal for a gray display so as to retain the data signal for the gray display, the data signal for the gray display having a polarity identical to a polarity of a data signal supplied to said each of the data signal lines immediately before the vertical blanking interval.

According to the invention, in a case where a single color image is displayed, the following occurs at a start of the vertical blanking interval. That is, in a case of a normally black display, in a case where a data signal supplied to a picture element in the last row of one (1) frame has a positive polarity, an electric potential of a picture element electrode of a picture element (subject picture element) to which a data signal for the single color is written is (i) affected and reduced by, via parasitic capacitance between the picture element electrode of the subject picture element and a data signal line corresponding to the subject picture element, a change of an electric potential of the data signal line corresponding to the subject picture element to an electric potential for a gray display and (ii) affected and reduced by, via parasitic capacitance between the picture element electrode of the subject picture element and a data signal line corresponding to an adjacent picture element, a change of an electric potential of the data signal line corresponding to the adjacent picture element to an electric potential for a gray display. That is, the picture element electrode of the subject picture element undergoes a change in its electric potential so that the electric potential as a whole decreases. On the other hand, in a case where the data signal supplied to the picture element in the last row of one (1) frame has a negative polarity, the picture element electrode of the picture element undergoes a change in its electric potential so that the electric potential as a whole increases.

Accordingly, in a case where the data signal written to the picture element in the last row of one (1) frame has a positive polarity, an effective value of a positive voltage applied to liquid crystal in the subject picture element is smaller than that of a conventional technique, whereas an effective value of a negative voltage applied to liquid crystal in the subject picture element is larger than that of a conventional technique. On the other hand, in a case where the data signal written to the picture element in the last row of one (1) frame has a negative polarity, the effective value of the positive voltage applied to liquid crystal in the subject picture element is larger than that of a conventional technique, whereas the effective value of the negative voltage applied to liquid crystal in the subject picture element is smaller than that of a conventional technique. As a result, the effective value of the positive voltage applied to liquid crystal and the effective value of the negative voltage applied to liquid crystal are close to each other as compared to a conventional technique or are equal to each other.

On the other hand, in a case of a normally white display, the following occurs. That is, in a case where a data signal written to a picture element in the last row of one (1) frame has a positive polarity, an effective value of a voltage applied to liquid crystal in a subject picture element to which a positive data signal for the single color is written is larger than that of a conventional technique, whereas an effective value of a voltage applied to liquid crystal in a subject picture element to which a negative data signal for the single color is written is smaller than that of a conventional technique. On the other hand, in a case where the data signal written to the picture element in the last row of one (1) frame has a negative polarity, an effective value of a positive voltage applied to liquid crystal in the subject picture element is smaller than that of a conventional technique, whereas an effective value of a negative voltage applied to liquid crystal in the subject picture element is larger than that of a conventional technique. As a result, the effective value of the positive voltage applied to liquid crystal and the effective value of the negative voltage applied to liquid crystal are close to each other as compared to a conventional technique or are equal to each other.

Accordingly, it is possible to achieve a display device in which, while an AC driving is carried out so that (i) data signals having opposite polarities are written to respective picture elements adjacent to each other within the same row, (ii) a polarity of a data signal supplied to each data signal line is reversed at least once during one (1) vertical period, and (iii) a polarity of a data signal written to each picture element is reversed for every predetermined period, an effective value of a voltage applied to liquid crystal is less likely to differ between a picture element to which a data signal having a positive polarity is written and a picture element to which a data signal having a negative polarity is written.

In order to attain the above object, a display device in accordance with the present invention is an active matrix display device, including: picture elements; and data signal lines, the active matrix display device employing an AC driving in which (i) data signals having opposite polarities are written to respective adjacent ones, of the picture elements, which are adjacent to each other within a same row, (ii) a polarity of a data signal supplied to each of the data signal lines is reversed at least once during one (1) vertical period, and (iii) a polarity of a data signal written to each of the picture elements is reversed for every predetermined period,

during a vertical blanking interval, each of the data signal lines being supplied with a data signal for a gray display so as to retain the data signal for the gray display, the data signal for the gray display having a polarity reverse to a polarity of a data signal supplied to said each of the data signal lines immediately before the vertical blanking interval.

According to the invention, in a case where a single color image is displayed, the following occurs at a start of the vertical blanking interval. That is, in a case of a normally black display, in a case where a data signal supplied to a picture element in the last row of one (1) frame has a positive polarity, an electric potential of a picture element electrode of a picture element (subject picture element) to which a data signal for the single color is written is (i) affected and largely reduced by, via parasitic capacitance between the picture element electrode of the subject picture element and a data signal line corresponding to the subject picture element, a change of an electric potential of the data signal line corresponding to the subject picture element to an electric potential for a gray display and (ii) affected and slightly increased by, via parasitic capacitance between the picture element electrode of the subject picture element and a data signal line corresponding to an adjacent picture element, a change of an electric potential of the data signal line corresponding to the adjacent picture element to an electric potential for a gray display. That is, the picture element electrode of the subject picture element undergoes a change in its electric potential so that the electric potential as a whole decreases. On the other hand, in a case where the data signal supplied to the picture element in the last row of one (1) frame has a negative polarity, the picture element electrode of the picture element undergoes a change in its electric potential so that the electric potential as a whole increases.

Accordingly, in a case where the data signal written to the picture element in the last row of one (1) frame has a positive polarity, an effective value of a positive voltage applied to liquid crystal in the subject picture element is smaller than that of a conventional technique, whereas an effective value of a negative voltage applied to liquid crystal in the subject picture element is larger than that of a conventional technique. On the other hand, in a case where the data signal written to the picture element in the last row of one (1) frame has a negative polarity, the effective value of the positive voltage applied to liquid crystal in the subject picture element is larger than that of a conventional technique, whereas the effective value of the negative voltage applied to liquid crystal in the subject picture element is smaller than that of a conventional technique. As a result, the effective value of the positive voltage applied to liquid crystal and the effective value of the negative voltage applied to liquid crystal are close to each other as compared to a conventional technique or are equal to each other.

On the other hand, in a case of a normally white display, the following occurs. That is, in a case where a data signal written to a picture element in the last row of one (1) frame has a positive polarity, an effective value of a voltage applied to liquid crystal in a subject picture element to which a positive data signal for the single color is written is larger than that of a conventional technique, whereas an effective value of a voltage applied to liquid crystal in a subject picture element to which a negative data signal for the single color is written is smaller than that of a conventional technique. On the other hand, in a case where the data signal written to the picture element in the last row of one (1) frame has a negative polarity, an effective value of a positive voltage applied to liquid crystal in the subject picture element is smaller than that of a conventional technique, whereas an effective value of a negative voltage applied to liquid crystal in the subject picture element is larger than that of a conventional technique. As a result, the effective value of the positive voltage applied to liquid crystal and the effective value of the negative voltage applied to liquid crystal are close to each other as compared to a conventional technique or are equal to each other.

Accordingly, it is possible to achieve a display device in which, while an AC driving is carried out so that (i) data signals having opposite polarities are written to respective picture elements adjacent to each other within the same row, (ii) a polarity of a data signal supplied to each data signal line is reversed at least once during one (1) vertical period, and (iii) a polarity of a data signal written to each picture element is reversed for every predetermined period, an effective value of a voltage applied to liquid crystal is less likely to differ between a picture element to which a data signal having a positive polarity is written and a picture element to which a data signal having a negative polarity is written.

In order to attain the above object, a display device in accordance with the present invention is an active matrix display device, including: picture elements; and data signal lines, the active matrix display device employing an AC driving in which (i) data signals having opposite polarities are written to respective adjacent ones, of the picture elements, which are adjacent to each other within a same row, (ii) a polarity of a data signal supplied to each of the data signal lines is reversed at least once during one (1) vertical period, and (iii) a polarity of a data signal written to each of the picture elements is reversed for every predetermined period,

during a vertical blanking interval, each of the data signal lines being supplied with a data signal for a white display so as to retain the data signal for the white display, the data signal for the white display having a polarity identical to a polarity of a data signal supplied to said each of the data signal lines immediately before the vertical blanking interval.

According to the invention, in a case where a single color image is displayed, the following occurs at a start of the vertical blanking interval. That is, in a case of a normally black display, in a case where a data signal supplied to a picture element in the last row of one (1) frame has a positive polarity, an electric potential of a picture element electrode of a picture element (subject picture element) to which a data signal for the single color is written is (i) affected and reduced by, via parasitic capacitance between the picture element electrode of the subject picture element and a data signal line corresponding to the subject picture element, an electric potential of the data signal line corresponding to the subject picture element which electric potential remains the same and (ii) affected and reduced by, via parasitic capacitance between the picture element electrode of the subject picture element and a data signal line corresponding to an adjacent picture element, a change of an electric potential of the data signal line corresponding to the adjacent picture element to an electric potential for a white display. That is, the picture element electrode of the subject picture element undergoes a change in its electric potential so that the electric potential as a whole decreases. On the other hand, in a case where the data signal supplied to the picture element in the last row of one (1) frame has a negative polarity, the picture element electrode of the picture element undergoes a change in its electric potential so that the electric potential as a whole increases.

Accordingly, an effective value of a positive voltage applied to liquid crystal in the subject picture element is smaller than that of a conventional technique, whereas an effective value of a negative voltage applied to liquid crystal in the subject picture element is larger than that of a conventional technique. As a result, the effective value of the positive voltage applied to liquid crystal and the effective value of the negative voltage applied to liquid crystal are close to each other as compared to a conventional technique or are equal to each other.

On the other hand, in a case of a normally white display, the following occurs. That is, in a case where a data signal written to a picture element in the last row of one (1) frame has a positive polarity, an effective value of a voltage applied to liquid crystal in a subject picture element to which a positive data signal for the single color is written is larger than that of a conventional technique, whereas an effective value of a voltage applied to liquid crystal in a subject picture element to which a negative data signal for the single color is written is smaller than that of a conventional technique. On the other hand, in a case where the data signal written to the picture element in the last row of one (1) frame has a negative polarity, an effective value of a positive voltage applied to liquid crystal in the subject picture element is smaller than that of a conventional technique, whereas an effective value of a negative voltage applied to liquid crystal in the subject picture element is larger than that of a conventional technique. As a result, the effective value of the positive voltage applied to liquid crystal and the effective value of the negative voltage applied to liquid crystal are close to each other as compared to a conventional technique or are equal to each other.

Accordingly, it is possible to achieve a display device in which, while an AC driving is carried out so that (i) data signals having opposite polarities are written to respective picture elements adjacent to each other within the same row, (ii) a polarity of a data signal supplied to each data signal line is reversed at least once during one (1) vertical period, and (iii) a polarity of a data signal written to each picture element is reversed for every predetermined period, an effective value of a voltage applied to liquid crystal is less likely to differ between a picture element to which a data signal having a positive polarity is written and a picture element to which a data signal having a negative polarity is written.

In order to attain the above object, a display device in accordance with the present invention is an active matrix display device, including: picture elements; and data signal lines, the active matrix display device employing an AC driving in which (i) data signals having opposite polarities are written to respective adjacent ones, of the picture elements, which are adjacent to each other within a same row, (ii) a polarity of a data signal supplied to each of the data signal lines is reversed at least once during one (1) vertical period, and (iii) a polarity of a data signal written to each of the picture elements is reversed for every predetermined period,

during a vertical blanking interval, each of the data signal lines being supplied with a data signal for a white display so as to retain the data signal for the white display, the data signal for the white display having a polarity reverse to a polarity of a data signal supplied to said each of the data signal lines immediately before the vertical blanking interval.

According to the invention, in a case where a single color image is displayed, the following occurs at a start of the vertical blanking interval. That is, in a case of a normally black display, in a case where a data signal supplied to a picture element in the last row of one (1) frame has a positive polarity, an electric potential of a picture element electrode of a picture element (subject picture element) to which a data signal for the single color is written is (i) affected and largely reduced by, via parasitic capacitance between the picture element electrode of the subject picture element and a data signal line corresponding to the subject picture element, a change of an electric potential of the data signal line corresponding to the subject picture element to an electric potential for a white display and (ii) affected and slightly increased by, via parasitic capacitance between the picture element electrode of the subject picture element and a data signal line corresponding to an adjacent picture element, a change of an electric potential of the data signal line corresponding to the adjacent picture element to an electric potential for a white display. That is, the picture element electrode of the subject picture element undergoes a change in its electric potential so that the electric potential as a whole decreases. On the other hand, in a case where the data signal supplied to the picture element in the last row of one (1) frame has a negative polarity, the picture element electrode of the picture element undergoes a change in its electric potential so that the electric potential as a whole increases.

Accordingly, in a case where the data signal written to the picture element in the last row of one (1) frame has a positive polarity, an effective value of a positive voltage applied to liquid crystal in the subject picture element is smaller than that of a conventional technique, whereas, an effective value of a negative voltage applied to liquid crystal in the subject picture element is larger than that of a conventional technique. On the other hand, in a case where the data signal written to the picture element in the last row of one (1) frame has a negative polarity, the effective value of the positive voltage applied to liquid crystal in the subject picture element is larger than that of a conventional technique, whereas the effective value of the negative voltage applied to liquid crystal in the subject picture element is smaller than that of a conventional technique. As a result, the effective value of the positive voltage applied to liquid crystal and the effective value of the negative voltage applied to liquid crystal are close to each other as compared to a conventional technique or are equal to each other.

On the other hand, in a case of a normally white display, the following occurs. That is, in a case where a data signal written to a picture element in the last row of one (1) frame has a positive polarity, an effective value of a voltage applied to liquid crystal in a subject picture element to which a positive data signal for the single color is written is larger than that of a conventional technique, whereas an effective value of a voltage applied to liquid crystal in a subject picture element to which a negative data signal for the single color is written is smaller than that of a conventional technique. On the other hand, in a case where the data signal written to the picture element in the last row of one (1) frame has a negative polarity, an effective value of a positive voltage applied to liquid crystal in the subject picture element is smaller than that of a conventional technique, whereas an effective value of a negative voltage applied to liquid crystal in the subject picture element is larger than that of a conventional technique. As a result, the effective value of the positive voltage applied to liquid crystal and the effective value of the negative voltage applied to liquid crystal are close to each other as compared to a conventional technique or are equal to each other.

Accordingly, it is possible to achieve a display device in which, while an AC driving is carried out so that (i) data signals having opposite polarities are written to respective picture elements adjacent to each other within the same row, (ii) a polarity of a data signal supplied to each data signal line is reversed at least once during one (1) vertical period, and (iii) a polarity of a data signal written to each picture element is reversed for every predetermined period, an effective value of a voltage applied to liquid crystal is less likely to differ between a picture element to which a data signal having a positive polarity is written and a picture element to which a data signal having a negative polarity is written.

In order to attain the above object, a display device in accordance with the present invention is an active matrix display device, including: picture elements; and data signal lines, the active matrix display device employing an AC driving in which (i) data signals having opposite polarities are written to respective adjacent ones, of the picture elements, which are adjacent to each other within a same row, (ii) a polarity of a data signal supplied to each of the data signal lines is reversed at least once during one (1) vertical period, and (iii) a polarity of a data signal written to each of the picture elements is reversed for every predetermined period,

during a vertical blanking interval, each of the data signal lines being supplied with a data signal for a black display so as to retain the data signal for the black display, the data signal for the black display having a polarity identical to a polarity of a data signal supplied to said each of the data signal lines immediately before the vertical blanking interval.

According to the invention, in a case where a single color image is displayed, the following occurs at a start of the vertical blanking interval. That is, in a case of a normally black display, in a case where a data signal supplied to a picture element in the last row of one (1) frame has a positive polarity, an electric potential of a picture element electrode of a picture element (subject picture element) to which a data signal for the single color is written (i) is affected and reduced by, via parasitic capacitance between the picture element electrode of the subject picture element and a data signal line corresponding to the subject picture element, a change of an electric potential of the data signal line corresponding to the subject picture element to an electric potential for a black display and (ii) receives no affection via parasitic capacitance between the picture element electrode of the subject picture element and a data signal line corresponding to an adjacent picture element because there is no change in an electric potential of the data signal line corresponding to the adjacent picture element. That is, the picture element electrode of the subject picture element undergoes a change in its electric potential so that the electric potential as a whole decreases. On the other hand, in a case, where the data signal supplied to the picture element in the last row of one (1) frame has a negative polarity, the picture element electrode of the picture element undergoes a change in its electric potential so that the electric potential as a whole increases.

Accordingly, an effective value of a positive voltage applied to liquid crystal in the subject picture element is smaller than that of a conventional technique, whereas an effective value of a negative voltage applied to liquid crystal in the subject picture element is larger than that of a conventional technique. As a result, the effective value of the positive voltage applied to liquid crystal and the effective value of the negative voltage applied to liquid crystal are close to each other as compared to a conventional technique or are equal to each other.

On the other hand, in a case of a normally white display, the following occurs. That is, in a case where a data signal written to a picture element in the last row of one (1) frame has a positive polarity, an effective value of a voltage applied to liquid crystal in a subject picture element to which a positive data signal for the single color is written is larger than that of a conventional technique, whereas an effective value of a voltage applied to liquid crystal in a subject picture element to which a negative data signal for the single color is written is smaller than that of a conventional technique. On the other hand, in a case where the data signal written to the picture element in the last row of one (1) frame has a negative polarity, an effective value of a positive voltage applied to liquid crystal in the subject picture element is smaller than that of a conventional technique, whereas an effective value of a negative voltage applied to liquid crystal in the subject picture element is larger than that of a conventional technique. As a result, the effective value of the positive voltage applied to liquid crystal and the effective value of the negative voltage applied to liquid crystal are close to each other as compared to a conventional technique or are equal to each other.

Accordingly, it is possible to achieve a display device in which, while an AC driving is carried out so that (i) data signals having opposite polarities are written to respective picture elements adjacent to each other within the same row, (ii) a polarity of a data signal supplied to each data signal line is reversed at least once during one (1) vertical period, and (iii) a polarity of a data signal written to each picture element is reversed for every predetermined period, an effective value of a voltage applied to liquid crystal is less likely to differ between a picture element to which a data signal having a positive polarity is written and a picture element to which a data signal having a negative polarity is written.

In order to attain the above object, a display device in accordance with the present invention is an active matrix display device, including: picture elements; and data signal lines, the active matrix display device employing an AC driving in which (i) data signals having opposite polarities are written to respective adjacent ones, of the picture elements, which are adjacent to each other within a same row, (ii) a polarity of a data signal supplied to each of the data signal lines is reversed at least once during one (1) vertical period, and (iii) a polarity of a data signal written to each of the picture elements is reversed for every predetermined period,

during a vertical blanking interval, each of the data signal lines being supplied with a data signal for a black display so as to retain the data signal for the black display, the data signal for the black display having a polarity reverse to a polarity of a data signal supplied to said each of the data signal lines immediately before the vertical blanking interval.

According to the invention, in a case where a single color image is displayed, the following occurs at a start of the vertical blanking interval. That is, in a case of a normally black display, in a case where a data signal supplied to a picture element in the last row of one (1) frame has a positive polarity, an electric potential of a picture element electrode of a picture element (subject picture element) to which a data signal for the single color is written is (i) affected and largely reduced by, via parasitic capacitance between the picture element electrode of the subject picture element and a data signal line corresponding to the subject picture element, a change of an electric potential of the data signal line corresponding to the subject picture element to an electric potential for a black display and (ii) affected and slightly increased by, via parasitic capacitance between the picture element electrode of the subject picture element and a data signal line corresponding to an adjacent picture element, a change of an electric potential of the data signal line corresponding to the adjacent picture element to an electric potential for a black display. That is, the picture element electrode of the subject picture element undergoes a change in its electric potential so that the electric potential as a whole decreases. On the other hand, in a case where the data signal supplied to the picture element in the last row of one (1) frame has a negative polarity, the picture element electrode of the picture element undergoes a change in its electric potential so that the electric potential as a whole increases.

Accordingly, in a case where the data signal written to the picture element in the last row of one (1) frame has a positive polarity, an effective value of a positive voltage applied to liquid crystal in the subject picture element is smaller than that of a conventional technique, whereas an effective value of a negative voltage applied to liquid crystal in the subject picture element is larger than that of a conventional technique. On the other hand, in a case where the data signal written to the picture element in the last row of one (1) frame has a negative polarity, the effective value of the positive voltage applied to liquid crystal in the subject picture element is larger than that of a conventional technique, whereas the effective value of the negative voltage applied to liquid crystal in the subject picture element is smaller than that of a conventional technique. As a result, the effective value of the positive voltage applied to liquid crystal and the effective value of the negative voltage applied to liquid crystal are close to each other as compared to a conventional technique or are equal to each other.

On the other hand, in a case of a normally white display, the following occurs. That is, in a case where a data signal written to a picture element in the last row of one (1) frame has a positive polarity, an effective value of a voltage applied to liquid crystal in a subject picture element to which a positive data signal for the single color is written is larger than that of a conventional technique, whereas an effective value of a voltage applied to liquid crystal in a subject picture element to which a negative data signal for the single color is written is smaller than that of a conventional technique. On the other hand, in a case where the data signal written to the picture element in the last row of one (1) frame has a negative polarity, an effective value of a positive voltage applied to liquid crystal in the subject picture element is smaller than that of a conventional technique, whereas an effective value of a negative voltage applied to liquid crystal in the subject picture element is larger than that of a conventional technique. As a result, the effective value of the positive voltage applied to liquid crystal and the effective value of the negative voltage applied to liquid crystal are close to each other as compared to a conventional technique or are equal to each other.

Accordingly, it is possible to achieve a display device in which, while an AC driving is carried out so that (i) data signals having opposite polarities are written to respective picture elements adjacent to each other within the same row,

(ii) a polarity of a data signal supplied to each data signal line is reversed at least once during one (1) vertical period, and (iii) a polarity of a data signal written to each picture element is reversed for every predetermined period, an effective value of a voltage applied to liquid crystal is less likely to differ between a picture element to which a data signal having a positive polarity is written and a picture element to which a data signal having a negative polarity is written.

In order to attain the above object, the display device in accordance with the present invention is configured such that the predetermined period is one (1) frame period.

According to the invention, it is possible to achieve a display device in which, while an AC driving is carried out so that a polarity of a data signal written to each picture element is reversed for every one (1) frame period, an effective value of a voltage applied to liquid crystal is less likely to differ between a picture element to which a data signal having a positive polarity is written and a picture element to which a data signal having a negative polarity is written.

In order to attain the above object, the display device in accordance with the present invention is configured such that each of the data signal lines has (i) a region facing a picture element electrode of a first picture element to which a data signal supplied through said each of the data signal lines is written and (ii) a region facing a picture element electrode of a second picture element that is adjacent to the first picture element within a same row.

According to the invention, there is large parasitic capacitance (i) between the each of the data signal lines and the picture element electrode of the picture element to which the data signal supplied through the each of the data signal lines is written and (ii) between the each of the data signal lines and the picture element electrode of the picture element adjacent within the same row to the picture element to which the data signal supplied through the each of the data signal lines is written. This makes it possible to particularly effectively reduce a difference between (a) an effective value of a voltage applied to liquid crystal in a picture element to which a positive data signal is written and (b) an effective value of a voltage applied to liquid crystal in a picture element to which a negative data signal is written.

In order to attain the above object, a method for driving a display device in accordance with the present invention is a method for driving an active matrix display device, the active matrix display device (i) including picture elements and data signal lines and (ii) employing an AC driving in which (a) data signals having opposite polarities are written to respective adjacent ones, of the picture elements, which are adjacent to each other within a same row, (b) a polarity of a data signal supplied to each of the data signal lines is reversed at least once during one (1) vertical period, and (c) a polarity of a data signal written to each of the picture elements is reversed for every predetermined period,

said method, including the step of: supplying, during a vertical blanking interval, a data signal for a gray display to each of the data signal lines so as to cause said each of the data signal lines to retain the data signal for the gray display, the data signal for the gray display having a polarity identical to a polarity of a data signal supplied to said each of the data signal lines immediately before the vertical blanking interval.

According to the invention, in a case where a single color image is displayed, the following occurs at a start of the vertical blanking interval. That is, in a case of a normally black display, in a case where a data signal supplied to a picture element in the last row of one (1) frame has a positive polarity, an electric potential of a picture element electrode of a picture element (subject picture element) to which a data signal for the single color is written is (i) affected and reduced by, via parasitic capacitance between the picture element electrode of the subject picture element and a data signal line corresponding to the subject picture element, a change of an electric potential of the data signal line corresponding to the subject picture element to an electric potential for a gray display and (ii) affected and reduced by, via parasitic capacitance between the picture element electrode of the subject picture element and a data signal line corresponding to an adjacent picture element, a change of an electric potential of the data signal line corresponding to the adjacent picture element to an electric potential for a gray display. That is, the picture element electrode of the subject picture element undergoes a change in its electric potential so that the electric potential as a whole decreases. On the other hand, in a case where the data signal supplied to the picture element in the last row of one (1) frame has a negative polarity, the picture element electrode of the picture element undergoes a change in its electric potential so that the electric potential as a whole increases.

Accordingly, in a case where the data signal written to the picture element in the last row of one (1) frame has a positive polarity, an effective value of a positive voltage applied to liquid crystal in the subject picture element is smaller than that of a conventional technique, whereas an effective value of a negative voltage applied to liquid crystal in the subject picture element is larger than that of a conventional technique. On the other hand, in a case where the data signal written to the picture element in the last row of one (1) frame has a negative polarity, the effective value of the positive voltage applied to liquid crystal in the subject picture element is larger than that of a conventional technique, whereas the effective value of the negative voltage applied to liquid crystal in the subject picture element is smaller than that of a conventional technique. As a result, the effective value of the positive voltage applied to liquid crystal and the effective value of the negative voltage applied to liquid crystal are close to each other as compared to a conventional technique or are equal to each other.

On the other hand, in a case of a normally white display, the following occurs. That is, in a case where a data signal written to a picture element in the last row of one (1) frame has a positive polarity, an effective value of a voltage applied to liquid crystal in a subject picture element to which a positive data signal for the single color is written is larger than that of a conventional technique, whereas an effective value of a voltage applied to liquid crystal in a subject picture element to which a negative data signal for the single color is written is smaller than that of a conventional technique. On the other hand, in a case where the data signal written to the picture element in the last row of one (1) frame has a negative polarity, an effective value of a positive voltage applied to liquid crystal in the subject picture element is smaller than that of a conventional technique, whereas an effective value of a negative voltage applied to liquid crystal in the subject picture element is larger than that of a conventional technique. As a result, the effective value of the positive voltage applied to liquid crystal and the effective value of the negative voltage applied to liquid crystal are close to each other as compared to a conventional technique or are equal to each other.

Accordingly, it is possible to achieve a method for driving a display device in which, while an AC driving is carried out so that (i) data signals having opposite polarities are written to respective picture elements adjacent to each other within the same row, (ii) a polarity of a data signal supplied to each data signal line is reversed at least once during one (1) vertical period, and (iii) a polarity of a data signal written to each picture element is reversed for every predetermined period, an effective value of a voltage applied to liquid crystal is less likely to differ between a picture element to which a data signal having a positive polarity is written and a picture element to which a data signal having a negative polarity is written.

In order to attain the above object, a method for diving a display device in accordance with the present invention is a method for driving an active matrix display device, the active matrix display device (i) including picture elements and data signal lines and (ii) employing an AC driving in which (a) data signals having opposite polarities are written to respective adjacent ones, of the picture elements, which are adjacent to each other within a same row, (b) a polarity of a data signal supplied to each of the data signal lines is reversed at least once during one (1) vertical period, and (c) a polarity of a data signal written to each of the picture elements is reversed for every predetermined period,

said method, including the step of: supplying, during a vertical blanking interval, a data signal for a gray display to each of the data signal lines so as to cause said each of the data signal lines to retain the data signal for the gray display, the data signal for the gray display having a polarity reverse to a polarity of a data signal supplied to said each of the data signal lines immediately before the vertical blanking interval.

According to the invention, in a case where a single color image is displayed, the following occurs at a start of the vertical blanking interval. That is, in a case of a normally black display, in a case where a data signal supplied to a picture element in the last row of one (1) frame has a positive polarity, an electric potential of a picture element electrode of a picture element (subject picture element) to which a data signal for the single color is written is (i) affected and largely reduced by, via parasitic capacitance between the picture element electrode of the subject picture element and a data signal line corresponding to the subject picture element, a change of an electric potential of the data signal line corresponding to the subject picture element to an electric potential for a gray display and (ii) affected and slightly increased by, via parasitic capacitance between the picture element electrode of the subject picture element and a data signal line corresponding to an adjacent picture element, a change of an electric potential of the data signal line corresponding to the adjacent picture element to an electric potential for a gray display. That is, the picture element electrode of the subject picture element undergoes a change in its electric potential so that the electric potential as a whole decreases. On the other hand, in a case where the data signal supplied to the picture element in the last row of one (1) frame has a negative polarity, the picture element electrode of the picture element undergoes a change in its electric potential so that the electric potential as a whole increases.

Accordingly, in a case where the data signal written to the picture element in the last row of one (1) frame has a positive polarity, an effective value of a positive voltage applied to liquid crystal in the subject picture element is smaller than that of a conventional technique, whereas an effective value of a negative voltage applied to liquid crystal in the subject picture element is larger than that of a conventional technique. On the other hand, in a case where the data signal written to the picture element in the last row of one (1) frame has a negative polarity, the effective value of the positive voltage applied to liquid crystal in the subject picture element is larger than that of a conventional technique, whereas the effective value of the negative voltage applied to liquid crystal in the subject picture element is smaller than that of a conventional technique. As a result, the effective value of the positive voltage applied to liquid crystal and the effective value of the negative voltage applied to liquid crystal are close to each other as compared to a conventional technique or are equal to each other.

On the other hand, in a case of a normally white display, the following occurs. That is, in a case where a data signal written to a picture element in the last row of one (1) frame has a positive polarity, an effective value of a voltage applied to liquid crystal in a subject picture element to which a positive data signal for the single color is written is larger than that of a conventional technique, whereas an effective value of a voltage applied to liquid crystal in a subject picture element to which a negative data signal for the single color is written is smaller than that of a conventional technique. On the other hand, in a case where the data signal written to the picture element in the last row of one (1) frame has a negative polarity, an effective value of a positive voltage applied to liquid crystal in the subject picture element is smaller than that of a conventional technique, whereas an effective value of a negative voltage applied to liquid crystal in the subject picture element is larger than that of a conventional technique. As a result, the effective value of the positive voltage applied to liquid crystal and the effective value of the negative voltage applied to liquid crystal are close to each other as compared to a conventional technique or are equal to each other.

Accordingly, it is possible to achieve a method for driving a display device in which, while an AC driving is carried out so that (i) data signals having opposite polarities are written to respective picture elements adjacent to each other within the same row, (ii) a polarity of a data signal supplied to each data signal line is reversed at least once during one (1) vertical period, and (iii) a polarity of a data signal written to each picture element is reversed for every predetermined period, an effective value of a voltage applied to liquid crystal is less likely to differ between a picture element to which a data signal having a positive polarity is written and a picture element to which a data signal having a negative polarity is written.

In order to attain the above object, a method for driving a display device in accordance with the present invention is a method for driving an active matrix display device, the active matrix display device (i) including picture elements and data signal lines and (ii) employing an AC driving in which (a) data signals having opposite polarities are written to respective adjacent ones, of the picture elements, which are adjacent to each other within a same row, (b) a polarity of a data signal supplied to each of the data signal lines is reversed at least once during one (1) vertical period, and (c) a polarity of a data signal written to each of the picture elements is reversed for every predetermined period,

said method, including the step of: supplying, during a vertical blanking interval, a data signal for a white display to each of the data signal lines so as to cause said each of the data signal lines to retain the data signal for the white display, the data signal for the white display having a polarity identical to a polarity of a data signal supplied to said each of the data signal lines immediately before the vertical blanking interval.

According to the invention, in a case where a single color image is displayed, the following occurs at a start of the vertical blanking interval. That is, in a case of a normally black display, in a case where a data signal supplied to a picture element in the last row of one (1) frame has a positive polarity, an electric potential of a picture element electrode of a picture element (subject picture element) to which a data signal for the single color is written is (i) affected and reduced by, via parasitic capacitance between the picture element electrode of the subject picture element and a data signal line corresponding to the subject picture element, an electric potential of the data signal line corresponding to the subject picture element which electric potential remains the same and (ii) affected and reduced by, via parasitic capacitance between the picture element electrode of the subject picture element and a data signal line corresponding to an adjacent picture element, a change of an electric potential of the data signal line corresponding to the adjacent picture element to an electric potential for a white display. That is, the picture element electrode of the subject picture element undergoes a change in its electric potential so that the electric potential as a whole decreases. On the other hand, in a case where the data signal supplied to the picture element in the last row of one (1) frame has a negative polarity, the picture element electrode of the picture element undergoes a change in its electric potential so that the electric potential as a whole increases.

Accordingly, an effective value of a positive voltage applied to liquid crystal in the subject picture element is smaller than that of a conventional technique, whereas an effective value of a negative voltage applied to liquid crystal in the subject picture element is larger than that of a conventional technique. As a result, the effective value of the positive voltage applied to liquid crystal and the effective value of the negative voltage applied to liquid crystal are close to each other as compared to a conventional technique or are equal to each other.

On the other hand, in a case of a normally white display, the following occurs. That is, in a case where a data signal written to a picture element in the last row of one (1) frame has a positive polarity, an effective value of a voltage applied to liquid crystal in a subject picture element to which a positive data signal for the single color is written is larger than that of a conventional technique, whereas an effective value of a voltage applied to liquid crystal in a subject picture element to which a negative data signal for the single color is written is smaller than that of a conventional technique. On the other hand, in a case where the data signal written to the picture element in the last row of one (1) frame has a negative polarity, an effective value of a positive voltage applied to liquid crystal in the subject picture element is smaller than that of a conventional technique, whereas an effective value of a negative voltage applied to liquid crystal in the subject picture element is larger than that of a conventional technique. As a result, the effective value of the positive voltage applied to liquid crystal and the effective value of the negative voltage applied to liquid crystal are close to each other as compared to a conventional technique or are equal to each other.

Accordingly, it is possible to achieve a method for driving a display device in which, while an AC driving is carried out so that (i) data signals having opposite polarities are written to respective picture elements adjacent to each other within the same row, (ii) a polarity of a data signal supplied to each data signal line is reversed at least once during one (1) vertical period, and (iii) a polarity of a data signal written to each picture element is reversed for every predetermined period, an effective value of a voltage applied to liquid crystal is less likely to differ between a picture element to which a data signal having a positive polarity is written and a picture element to which a data signal having a negative polarity is written.

In order to attain the above object, a method for driving a display device in accordance with the present invention is a method for driving an active matrix display device, the active matrix display device (i) including picture elements and data signal lines and (ii) employing an AC driving in which (a) data signals having opposite polarities are written to respective adjacent ones, of the picture elements, which are adjacent to each other within a same row, (b) a polarity of a data signal supplied to each of the data signal lines is reversed at least once during one (1) vertical period, and (c) a polarity of a data signal written to each of the picture elements is reversed for every predetermined period,

said method, including the step of: supplying, during a vertical blanking interval, a data signal for a white display to each of the data signal lines so as to cause said each of the data signal lines to retain the data signal for the white display, the data signal for the white display having a polarity reverse to a polarity of a data signal supplied to said each of the data signal lines immediately before the vertical blanking interval.

According to the invention, in a case where a single color image is displayed, the following occurs at a start of the vertical blanking interval. That is, in a case of a normally black display, in a case where a data signal supplied to a picture element in the last row of one (1) frame has a positive polarity, an electric potential of a picture element electrode of a picture element (subject picture element) to which a data signal for the single color is written is (i) affected and largely reduced by, via parasitic capacitance between the picture element electrode of the subject picture element and a data signal line corresponding to the subject picture element, a change of an electric potential of the data signal line corresponding to the subject picture element to an electric potential for a white display and affected and slightly increased by, via parasitic capacitance between the picture element electrode of the subject picture element and a data signal line corresponding to an adjacent picture element, a change of an electric potential of the data signal line corresponding to the adjacent picture element to an electric potential for a white display. That is, the picture element electrode of the subject picture element undergoes a change in its electric potential so that the electric potential as a whole decreases. On the other hand, in a case where the data signal supplied to the picture element in the last row of one (1) frame has a negative polarity, the picture element electrode of the picture element undergoes a change in its electric potential so that the electric potential as a whole increases.

Accordingly, in a case where the data signal written to the picture element in the last row of one (1) frame has a positive polarity, an effective value of a positive voltage applied to liquid crystal in the subject picture element is smaller than that of a conventional technique, whereas an effective value of a negative voltage applied to liquid crystal in the subject picture element is larger than that of a conventional technique. On the other hand, in a case where the data signal written to the picture element in the last row of one (1) frame has a negative polarity, the effective value of the positive voltage applied to liquid crystal in the subject picture element is larger than that of a conventional technique, whereas the effective value of the negative voltage applied to liquid crystal in the subject picture element is smaller than that of a conventional technique. As a result, the effective value of the positive voltage applied to liquid crystal and the effective value of the negative voltage applied to liquid crystal are close to each other as compared to a conventional technique or are equal to each other.

On the other hand, in a case of a normally white display, the following occurs. That is, in a case where a data signal written to a picture element in the last row of one (1) frame has a positive polarity, an effective value of a voltage applied to liquid crystal in a subject picture element to which a positive data signal for the single color is written is larger than that of a conventional technique, whereas an effective value of a voltage applied to liquid crystal in a subject picture element to which a negative data signal for the single color is written is smaller than that of a conventional technique. On the other hand, in a case where the data signal written to the picture element in the last row of one (1) frame has a negative polarity, an effective value of a positive voltage applied to liquid crystal in the subject picture element is smaller than that of a conventional technique, whereas an effective value of a negative voltage applied to liquid crystal in the subject picture element is larger than that of a conventional technique. As a result, the effective value of the positive voltage applied to liquid crystal and the effective value of the negative voltage applied to liquid crystal are close to each other as compared to a conventional technique or are equal to each other.

Accordingly, it is possible to achieve a method for driving a display device in which, while an AC driving is carried out so that (i) data signals having opposite polarities are written to respective picture elements adjacent to each other within the same row, (ii) a polarity of a data signal supplied to each data signal line is reversed at least once during one (1) vertical period, and (iii) a polarity of a data signal written to each picture element is reversed for every predetermined period, an effective value of a voltage applied to liquid crystal is less likely to differ between a picture element to which a data signal having a positive polarity is written and a picture element to which a data signal having a negative polarity is written.

In order to attain the above object, a method for driving a display device in accordance with the present invention is a method for driving an active matrix display device, the active matrix display device (i) including picture elements and data signal lines and (ii) employing an AC driving in which (a) data signals having opposite polarities are written to respective adjacent ones, of the picture elements, which are adjacent to each other within a same row, (b) a polarity of a data signal supplied to each of the data signal lines is reversed at least once during one (1) vertical period, and (c) a polarity of a data signal written to each of the picture elements is reversed for every predetermined period,

said method, including the step of: supplying, during a vertical blanking interval, a data signal for a black display to each of the data signal lines so as to cause said each of the data signal lines to retain the data signal for the black display, the data signal for the black display having a polarity identical to a polarity of a data signal supplied to said each of the data signal lines immediately before the vertical blanking interval.

According to the invention, in a case where a single color image is displayed, the following occurs at a start of the vertical blanking interval. That is, in a case of a normally black display, in a case where a data signal supplied to a picture element in the last row of one (1) frame has a positive polarity, an electric potential of a picture element electrode of a picture element (subject picture element) to which a data signal for the single color is written (i) is affected and reduced by, via parasitic capacitance between the picture element electrode of the subject picture element and a data signal line corresponding to the subject picture element, a change of an electric potential of the data signal line corresponding to the subject picture element to an electric potential for a black display and (ii) receives no affection via parasitic capacitance between the picture element electrode of the subject picture element and a data signal line corresponding to an adjacent picture element because there is no change in an electric potential of the data signal line corresponding to the adjacent picture element. That is, the picture element electrode of the subject picture element undergoes a change in its electric potential so that the electric potential as a whole decreases. On the other hand, in a case where the data signal supplied to the picture element in the last row of one (1) frame has a negative polarity, the picture element electrode of the picture element undergoes a change in its electric potential so that the electric potential as a whole increases.

Accordingly, an effective value of a positive voltage applied to liquid crystal in the subject picture element is smaller than that of a conventional technique, whereas an effective value of a negative voltage applied to liquid crystal in the subject picture element is larger than that of a conventional technique. As a result, the effective value of the positive voltage applied to liquid crystal and the effective value of the negative voltage applied to liquid crystal are close to each other as compared to a conventional technique or are equal to each other.

On the other hand, in a case of a normally white display, the following occurs. That is, in a case where a data signal written to a picture element in the last row of one (1) frame has a positive polarity, an effective value of a voltage applied to liquid crystal in a subject picture element to which a positive data signal for the single color is written is larger than that of a conventional technique, whereas an effective value of a voltage applied to liquid crystal in a subject picture element to which a negative data signal for the single color is written is smaller than that of a conventional technique. On the other hand, in a case where the data signal written to the picture element in the last row of one (1) frame has a negative polarity, an effective value of a positive voltage applied to liquid crystal in the subject picture element is smaller than that of a conventional technique, whereas an effective value of a negative voltage applied to liquid crystal in the subject picture element is larger than that of a conventional technique. As a result, the effective value of the positive voltage applied to liquid crystal and the effective value of the negative voltage applied to liquid crystal are close to each other as compared to a conventional technique or are equal to each other.

Accordingly, it is possible to achieve a method for driving a display device in which, while an AC driving is carried out so that (i) data signals having opposite polarities are written to respective picture elements adjacent to each other within the same row, (ii) a polarity of a data signal supplied to each data signal line is reversed at least once during one (1) vertical period, and (iii) a polarity of a data signal written to each picture element is reversed for every predetermined period, an effective value of a voltage applied to liquid crystal is less likely to differ between a picture element to which a data signal having a positive polarity is written and a picture element to which a data signal having a negative polarity is written.

In order to attain the above object, a method for driving a display device in accordance with the present invention is a method for driving an active matrix display device, the active matrix display device (i) including picture elements and data signal lines and (ii) employing an AC driving in which (a) data signals having opposite polarities are written to respective adjacent ones, of the picture elements, which are adjacent to each other within a same row, (b) a polarity of a data signal supplied to each of the data signal lines is reversed at least once during one (1) vertical period, and (c) a polarity of a data signal written to each of the picture elements is reversed for every predetermined period,

said method, including the step of: supplying, during a vertical blanking interval, a data signal for a black display to each of the data signal lines so as to cause said each of the data signal lines to retain the data signal for the black display, the data signal for the black display having a polarity reverse to a polarity of a data signal supplied to said each of the data signal lines immediately before the vertical blanking interval.

According to the invention, in a case where a single color image is displayed, the following occurs at a start of the vertical blanking interval. That is, in a case of a normally black display, in a case where a data signal supplied to a picture element in the last row of one (1) frame has a positive polarity, an electric potential of a picture element electrode of a picture element (subject picture element) to which a data signal for the single color is written is (i) affected and largely reduced by, via parasitic capacitance between the picture element electrode of the subject picture element and a data signal line corresponding to the subject picture element, a change of an electric potential of the data signal line corresponding to the subject picture element to an electric potential for a black display and (ii) affected and slightly increased by, via parasitic capacitance between the picture element electrode of the subject picture element and a data signal line corresponding to an adjacent picture element, a change of an electric potential of the data signal line corresponding to the adjacent picture element to an electric potential for a black display. That is, the picture element electrode of the subject picture element undergoes a change in its electric potential so that the electric potential as a whole decreases. On the other hand, in a case where the data signal supplied to the picture element in the last row of one (1) frame has a negative polarity, the picture element electrode of the picture element undergoes a change in its electric potential so that the electric potential as a whole increases.

Accordingly, in a case where the data signal written to the picture element in the last row of one (1) frame has a positive polarity, an effective value of a positive voltage applied to liquid crystal in the subject picture element is smaller than that of a conventional technique, whereas an effective value of a negative voltage applied to liquid crystal in the subject picture element is larger than that of a conventional technique. On the other hand, in a case where the data signal written to the picture element in the last row of one (1) frame has a negative polarity, the effective value of the positive voltage applied to liquid crystal in the subject picture element is larger than that of a conventional technique, whereas the effective value of the negative voltage applied to liquid crystal in the subject picture element is smaller than that of a conventional technique. As a result, the effective value of the positive voltage applied to liquid crystal and the effective value of the negative voltage applied to liquid crystal are close to each other as compared to a conventional technique or are equal to each other.

On the other hand, in a case of a normally white display, the following occurs. That is, in a case where a data signal written to a picture element in the last row of one (1) frame has a positive polarity, an effective value of a voltage applied to liquid crystal in a subject picture element to which a positive data signal for the single color is written is larger than that of a conventional technique, whereas an effective value of a voltage applied to liquid crystal in a subject picture element to which a negative data signal for the single color is written is smaller than that of a conventional technique. On the other hand, in a case where the data signal written to the picture element in the last row of one (1) frame has a negative polarity, an effective value of a positive voltage applied to liquid crystal in the subject picture element is smaller than that of a conventional technique, whereas an effective value of a negative voltage applied to liquid crystal in the subject picture element is larger than that of a conventional technique. As a result, the effective value of the positive voltage applied to liquid crystal and the effective value of the negative voltage applied to liquid crystal are close to each other as compared to a conventional technique or are equal to each other.

Accordingly, it is possible to achieve a method for driving a display device in which, while an AC driving is carried out so that (i) data signals having opposite polarities are written to respective picture elements adjacent to each other within the same row, (ii) a polarity of a data signal supplied to each data signal line is reversed at least once during one (1) vertical period, and (iii) a polarity of a data signal written to each picture element is reversed for every predetermined period, an effective value of a voltage applied to liquid crystal is less likely to differ between a picture element to which a data signal having a positive polarity is written and a picture element to which a data signal having a negative polarity is written.

In order to attain the above object, the method for driving the display device in accordance with the present invention is configured such that the predetermined period is one (1) frame period.

According to the invention, it is possible to achieve a method for driving a display device in which, while an AC driving is carried out so that a polarity of a data signal written to each picture element is reversed for every one (1) frame period, an effective value of a voltage applied to liquid crystal is less likely to differ between a picture element to which a data signal having a positive polarity is written and a picture element to which a data signal having a negative polarity is written.

In order to attain the above object, the method for driving the display device in accordance with the present invention is configured such that each of the data signal lines has (i) a region facing a picture element electrode of a first picture element to which a data signal supplied through said each of the data signal lines is written and (ii) a region facing a picture element electrode of a second picture element that is adjacent to the first picture element within a same row.

According to the invention, there is large parasitic capacitance (i) between the each of the data signal lines and the picture element electrode of the picture element to which the data signal supplied through the each of the data signal lines is written and (ii) between the each of the data signal lines and the picture element electrode of the picture element adjacent within the same row to the picture element to which the data signal supplied through the each of the data signal lines is written. This makes it possible to particularly effectively reduce a difference between (a) an effective value of a voltage applied to liquid crystal in a picture element to which a positive data signal is written and (b) an effective value of a voltage applied to liquid crystal in a picture element to which a negative data signal is written.

### INDUSTRIAL APPLICABILITY

The present invention is suitably applicable to various display devices such as a liquid crystal display device.

### REFERENCE SIGNS LIST

1 Liquid crystal display device (Display device)
SL, SL1 through SLn Source line (Data signal line)
Tv Vertical blanking interval

1. An active matrix display device, comprising:
picture elements; and
data signal lines,
the active matrix display device employing an AC driving in which (i) data signals having opposite polarities are written to respective adjacent ones, of the picture elements, which are adjacent to each other within a same row, (ii) a polarity of a data signal supplied to each of the data signal lines is reversed at least once during one (1) vertical period, and (iii) a polarity of a data signal written to each of the picture elements is reversed for every predetermined period,
during a vertical blanking interval, each of the data signal lines being supplied with a data signal for a gray display so as to retain the data signal for the gray display, the data signal for the gray display having a polarity identical to a polarity of a data signal supplied to said each of the data signal lines immediately before the vertical blanking interval.

2. An active matrix display device, comprising:
picture elements; and
data signal lines,
the active matrix display device employing an AC driving in which (i) data signals having opposite polarities are written to respective adjacent ones, of the picture elements, which are adjacent to each other within a same row, (ii) a polarity of a data signal supplied to each of the data signal lines is reversed at least once during one (1) vertical period, and (iii) a polarity of a data signal written to each of the picture elements is reversed for every predetermined period,
during a vertical blanking interval, each of the data signal lines being supplied with a data signal for a gray display so as to retain the data signal for the gray display, the data signal for the gray display having a polarity reverse to a polarity of a data signal supplied to said each of the data signal lines immediately before the vertical blanking interval.

3. An active matrix display device, comprising:
picture elements; and
data signal lines,
the active matrix display device employing an AC driving in which (i) data signals having opposite polarities are written to respective adjacent ones, of the picture elements, which are adjacent to each other within a same row, (ii) a polarity of a data signal supplied to each of the data signal lines is reversed at least once during one (1) vertical period, and (iii) a polarity of a data signal written to each of the picture elements is reversed for every predetermined period,
during a vertical blanking interval, each of the data signal lines being supplied with a data signal for a white display so as to retain the data signal for the white display, the data signal for the white display having a polarity identical to a polarity of a data signal supplied to said each of the data signal lines immediately before the vertical blanking interval.

4. An active matrix display device, comprising:
picture elements; and
data signal lines,
the active matrix display device employing an AC driving in which (i) data signals having opposite polarities are written to respective adjacent ones, of the picture elements, which are adjacent to each other within a same row, (ii) a polarity of a data signal supplied to each of the data signal lines is reversed at least once during one (1) vertical period, and (iii) a polarity of a data signal written to each of the picture elements is reversed for every predetermined period,
during a vertical blanking interval, each of the data signal lines being supplied with a data signal for a white display so as to retain the data signal for the white display, the data signal for the white display having a polarity reverse to a polarity of a data signal supplied to said each of the data signal lines immediately before the vertical blanking interval.

5. An active matrix display device, comprising:
picture elements; and
data signal lines,
the active matrix display device employing an AC driving in which (i) data signals having opposite polarities are written to respective adjacent ones, of the picture elements, which are adjacent to each other within a same row, (ii) a polarity of a data signal supplied to each of the data signal lines is reversed at least once during one (1) vertical period, and (iii) a polarity of a data signal written to each of the picture elements is reversed for every predetermined period,
during a vertical blanking interval, each of the data signal lines being supplied with a data signal for a black display so as to retain the data signal for the black display, the data signal for the black display having a polarity identical to a polarity of a data signal supplied to said each of the data signal lines immediately before the vertical blanking interval.

6. An active matrix display device, comprising:
picture elements; and
data signal lines,
the active matrix display device employing an AC driving in which (i) data signals having opposite polarities are written to respective adjacent ones, of the picture elements, which are adjacent to each other within a same row, (ii) a polarity of a data signal supplied to each of the data signal lines is reversed at least once during one (1) vertical period, and (iii) a polarity of a data signal written to each of the picture elements is reversed for every predetermined period,
during a vertical blanking interval, each of the data signal lines being supplied with a data signal for a black display so as to retain the data signal for the black display, the data signal for the black display having a polarity reverse to a polarity of a data signal supplied to said each of the data signal lines immediately before the vertical blanking interval.

7. The display device according to claim 1, wherein the predetermined period is one (1) frame period.

8. The display device according to claim 1, wherein each of the data signal lines has (i) a region facing a picture element electrode of a first picture element to which a data signal supplied through said each of the data signal lines is written and (ii) a region facing a picture element electrode of a second picture element that is adjacent to the first picture element within a same row.

9. A method for driving an active matrix display device, the active matrix display device (i) including picture elements and data signal lines and (ii) employing an AC driving in which (a) data signals having opposite polarities are written to respective adjacent ones, of the picture elements, which are adjacent to each other within a same row, (b) a polarity of a data signal supplied to each of the data signal lines is reversed at least once during one (1) vertical period, and (c) a polarity of a data signal written to each of the picture elements is reversed for every predetermined period,
said method, comprising the step of:
supplying, during a vertical blanking interval, a data signal for a gray display to each of the data signal lines so as to cause said each of the data signal lines to retain the data signal for the gray display, the data signal for the gray display having a polarity identical to a polarity of a data signal supplied to said each of the data signal lines immediately before the vertical blanking interval.

10. A method for driving an active matrix display device, the active matrix display device (i) including picture elements and data signal lines and (ii) employing an AC driving in which (a) data signals having opposite polarities are written to respective adjacent ones, of the picture elements, which are adjacent to each other within a same row, (b) a polarity of a data signal supplied to each of the data signal lines is reversed at least once during one (1) vertical period, and (c) a polarity of a data signal written to each of the picture elements is reversed for every predetermined period,
said method, comprising the step of:
supplying, during a vertical blanking interval, a data signal for a gray display to each of the data signal lines so as to cause said each of the data signal lines to retain the data signal for the gray display, the data signal for the gray display having a polarity reverse to a polarity of a data signal supplied to said each of the data signal lines immediately before the vertical blanking interval.

11. A method for driving an active matrix display device, the active matrix display device (i) including picture elements and data signal lines and (ii) employing an AC driving in which (a) data signals having opposite polarities are written to respective adjacent ones, of the picture elements, which are adjacent to each other within a same row, (b) a polarity of a data signal supplied to each of the data signal lines is reversed at least once during one (1) vertical period, and (c) a polarity of a data signal written to each of the picture elements is reversed for every predetermined period,
said method, comprising the step of:
supplying, during a vertical blanking interval, a data signal for a white display to each of the data signal lines so as to cause said each of the data signal lines to retain the data signal for the white display, the data signal for the white display having a polarity identical to a polarity of a data signal supplied to said each of the data signal lines immediately before the vertical blanking interval.

12. A method for driving an active matrix display device, the active matrix display device (i) including picture elements and data signal lines and (ii) employing an AC driving in which (a) data signals having opposite polarities are written to respective adjacent ones, of the picture elements, which are adjacent to each other within a same row, (b) a polarity of a data signal supplied to each of the data signal lines is reversed at least once during one (1) vertical period, and (c) a polarity of a data signal written to each of the picture elements is reversed for every predetermined period,
said method, comprising the step of:
supplying, during a vertical blanking interval, a data signal for a white display to each of the data signal lines so as to cause said each of the data signal lines to retain the data signal for the white display, the data signal for the white display having a polarity reverse to a polarity of a data signal supplied to said each of the data signal lines immediately before the vertical blanking interval.

13. A method for driving an active matrix display device, the active matrix display device (i) including picture elements and data signal lines and (ii) employing an AC driving in which (a) data signals having opposite polarities are written to respective adjacent ones, of the picture elements, which are adjacent to each other within a same row, (b) a polarity of a data signal supplied to each of the data signal lines is reversed at least once during one (1) vertical period, and (c) a polarity of a data signal written to each of the picture elements is reversed for every predetermined period,
said method, comprising the step of:
supplying, during a vertical blanking interval, a data signal for a black display to each of the data signal lines so as to cause said each of the data signal lines to retain the data signal for the black display, the data signal for the black display having a polarity identical to a polarity of a data signal supplied to said each of the data signal lines immediately before the vertical blanking interval.

14. A method for driving an active matrix display device, the active matrix display device (i) including picture elements and data signal lines and (ii) employing an AC driving in which (a) data signals having opposite polarities are written to respective adjacent ones, of the picture elements, which are adjacent to each other within a same row, (b) a polarity of a data signal supplied to each of the data signal lines is reversed at least once during one (1) vertical period, and (c) a polarity of a data signal written to each of the picture elements is reversed for every predetermined period,
said method, comprising the step of:
supplying, during a vertical blanking interval, a data signal for a black display to each of the data signal lines so as to cause said each of the data signal lines to retain the data signal for the black display, the data signal for the black display having a polarity reverse to a polarity of a data signal supplied to said each of the data signal lines immediately before the vertical blanking interval.

15. The method according to claim 9, wherein the predetermined period is one (1) frame period.

16. The method according to claim 9, wherein each of the data signal lines has (i) a region facing a picture element electrode of a first picture element to which a data signal supplied through said each of the data signal lines is written and (ii) a region facing a picture element electrode of a second picture element that is adjacent to the first picture element within a same row.
